(19) United States
(12) Patent Application Publication
(10) Pub. No.: US 2016/0354758 A1
(43) Pub. Date: Dec. 8, 2016

(54) Thermally Modified Polymeric Organosilicon Material, Method for Preparing Said Material and the Uses Thereof

(71) Applicants: Tadeusz GORECKI, Breslau (CA); Matthew Kip EDWARDS, Orangeville (CA)

(72) Inventors: Tadeusz GORECKI, Breslau (CA); Matthew Kip EDWARDS, Orangeville (CA)

(21) Appl. No.: 15/173,559

(22) Filed: Jun. 3, 2016

Related U.S. Application Data
(60) Provisional application No. 62/170,480, filed on Jun. 3, 2015.

(51) Int. Cl. B01J 20/285; C08G 77/04; B01D 15/18; B01D 15/24; B01J 20/26; B01D 53/02; G01N 30/54; G01N 30/46; B01J 20/30; C08G 77/00; B01D 15/20

(52) U.S. Cl. CPC B01J 20/285; C08G 77/80; C08G 77/04; B01D 15/1878; B01D 15/24; B01D 15/206; B01D 53/025; G01N 30/54; G01N 30/463; B01J 20/3078; B01J 20/262; B01D 2253/20; B01D 2253/25; G01N 2030/525

(57) ABSTRACT

Materials obtained by thermal modification of polymeric organosilicons such as polydimethylsiloxane (PDMS) or derivatives of PDMS. Methods of preparing said materials and uses of said materials.

### CROSS REFERENCE

This application claims the benefit of U.S. Provisional Patent Application No. 62/170,480, which is incorporated herein by reference in its entirety.

### FIELD OF THE INVENTION

The present invention relates to materials comprising thermally modified polymeric organosilicon. More specifically, the invention relates to materials obtained by thermal modification of polydimethylsiloxane (PDMS) or derivatives of PDMS. The invention further relates to methods of preparing said material and to the use of said material.

### BACKGROUND OF THE INVENTION

Chemical separations are a crucial step in the analysis of complex mixtures. Many technologies exist today to complete this task and they include liquid chromatography, gas chromatography (GC) and capillary electrophoresis. With regard to the separation of complex mixtures of volatile and semi-volatile chemicals, GC is the technique of choice. With the demands of industry and academia becoming increasingly focused on lower detection limits, better separation power and reproducibility of the results, the push to develop faster, more capable instruments and improved sorbent materials has followed suit.

Development of stationary phase sorbent materials to improve chromatographic separations is an area of great interest. Many different materials, including a variety of polymeric materials, have been studied for applications as stationary phase materials for chromatography.

Polydimethylsiloxane (PDMS) is a silicon based polymer having the structure shown in Formula I below. PDMS belongs to the group of polymeric organosilicons known as silicones. PDMS is used in many applications including as a stationary phase in gas chromatography columns. PDMS is also known to be optically and chemically inert under a wide range of conditions.

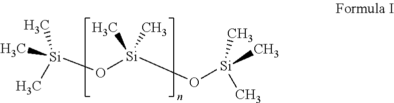

Derivatives of PDMS are also known including end capped derivatives and derivatives comprising substitution of the siloxane backbone. Examples of substituted PDMS polymers are cyanopropyl-phenyl-dimethylsiloxane, phenyl-dimethylsiloxane, trifluropropyl dimethyl siloxane.

Thermal degradation of PDMS has been known to occur by two different mechanisms. At moderately high temperatures (approximately 752-900 K) and a slow rate of heating, degradation has been found to occur via depolymeriziation of the polysiloxane backbone leading to formation of cyclosiloxanes. These cyclosiloxanes appear as column bleed when PDMS separation columns are used in high temperature GC applications. At temperatures above 900K and a fast rate of heating, degradation of PDMS is known to occur through a radical mechanism. This mechanism is thought to occur through Si—CH₃ bond cleavage followed by hydrogen abstraction to form methane.

While gas chromatography (GC) has long been used for the separation of volatile and semi-volatile compounds, comprehensive two-dimensional gas chromatography (GC×GC) was first demonstrated in 1990 by John Phillips. This technique offered an order of magnitude greater separation power than conventional GC. Whereas GC separates chemical mixtures in a single capillary column containing a selective stationary phase coating, GC×GC operates by separating mixtures first on one column offering a unique selectivity, then trapping, focusing, and injecting these separated compounds into a secondary column offering a differing selectivity. This allows mixtures to be separated using two different selectivity mechanisms, offering a significant increase in separation power and the ability to produce two- and three-dimensional chromatograms. The main component that allows this separation to be completed is the modulator, which allows the interfacing of two columns to each other and serves to trap, focus and inject the chemical sample being analyzed from one column to the next.

GC×GC has existed for over twenty years and within the last decade several instrument manufacturers have made modulation systems commercially available. However, these systems are very expensive to both purchase and operate.

Cryogenic modulators which use liquid nitrogen to cool and refocus the sample in trap have been successful in both industry and the research sector. These modulators use liquid nitrogen to cool and trap all of the components eluting from the first dimension. After a fixed time interval, a hot stream pulse is used to mobilize a part of the compounds again. This hot pulse can be considered as the injection starting point into the second dimension column. The use of large amounts of liquid nitrogen makes these systems expensive to run.

Due to customer demand for instruments that are less expensive to operate, new modulators that do not require consumables have been developed. These consumable-free GC×GC systems utilise a closed cycle refrigerated loop to cool the gas that then cools the trapping portions of the capillary column. These systems have several drawbacks. They do not operate efficiently for the most volatile compounds, with effective trapping beginning with C-8 hydrocarbons or equivalent. Like the liquid nitrogen-cooled system, these systems rely on a series of hot and cold jets for heat transfer to and from the trapping capillary. The operation of the jets is challenging for the user to optimise properly, increasing the complexity of the device. Some systems feature a delay loop that provides an additional optimisation challenge for the user because the required length of the loop depends on the carrier gas flow rate. Initial acquisition costs of these systems are also quite high. Most importantly, because of the indirect heat transfer to and from the trapping capillary, the reproducibility of the second dimension retention times is rather poor, which makes it necessary to use complicated algorithms for alignment of multiple chromatograms before any kind of chemometric analysis of data. This is a serious limitation in some applications, such as, in metabolomics, where GC×GC is the separation tool of choice.

Flow modulation system based on valves and flow switching that require no consumables have also been developed. Such system cannot be paired directly with mass spectrometry due to high carrier gas flow rates through the secondary column. Splitting of the carrier gas flow before the MS can be used, but results in loss of sensitivity. Ability to couple with mass spectrometry is vital, as MS is considered one of the most important detection systems available to analytical chemists. Valve based systems are generally inferior to thermal modulation systems in their capabilities. Optimising this type of modulator is also challenging due to its complex setup of valves and transfer lines.

There is a need for improved materials for use as sorbents and as the stationary phase for chromatography applications. In particular, there is a need for the development of material that can be used to improve GC separations or 2 dimensional GC separations as a stationary phase for columns or as a trap or modulator between columns in 2D GC applications.

### SUMMARY OF THE INVENTION

In one aspect of the invention there is provided a material comprising a polydimethylsiloxane (PDMS) polymer or derivative thereof wherein the polydimethylsiloxane polymers or derivative thereof is thermally modified. More specifically there is provided a modified PDMS or derivative of PDMS prepared by thermal treatment of a column containing PDMS or a derivative of PDMS at a temperature in the range of about 400° C. to 1000° C.

In an embodiment the modified material has a particulate form and more specifically is in the form of nanoparticles.

In still a further embodiment the PDMS polymer or derivative thereof is bound to a substrate during thermal modification. More particularly the substrate is the inner surface of a capillary column. The capillary column may be made of a variety of materials including steel or fused silica. In yet a further embodiment the thermal modification is carried out under oxidative conditions. In another embodiment the thermal modification is carried out by intermittent heating.

In another aspect of the invention there is provided a column containing a modified PDMS material or a modified PDMS derivative material prepared by thermal treatment of a column containing PDMS or a derivative of PDMS at a temperature in the range of about 400° C. to 1000° C.

In another aspect of the invention the modified PDMS material or modified PDMS derivative material is used as a sorbent.

In an embodiment the material is used as a sorbent for chemical separations or extractions. In a particular embodiment, the material is used as a sorbent for a gas chromatography (GC) column, a 2-dimensional GC modulator (trap) or a fiber coating for solid phase microextraction (SPME).

In another aspect of the invention there is a method of preparing a material comprising thermal treatment of PDMS or a derivative thereof. In an embodiment, the thermal treatment of PDMS or a derivative thereof results in a nanoparticulate material. In an embodiment of the method the thermal treatment is intermittent heat treatment. In still a further embodiment the thermal treatment is carried out in the presence of oxygen. In a further embodiment the thermal treatment is resistive heating. In still a further embodiment the PDMS or derivative thereof is bound to a substrate. In yet a further embodiment the substrate is a conductive material and the thermal treatment is resistive heating applied to the substrate.

In a further aspect of the invention there is provided a trap for use in a 2 dimensional gas chromatography system said trap comprising a conductive capillary column having an internal coating of PDMS that has been thermally treated to form a nanoparticulate material.

In a further aspect of the invention there is provided a trap for use in a 2D GC system the trap comprising a capillary column having an internal coating of PDMS or a derivative of PDMS that has been physically modified and thermally modified.

### BRIEF DESCRIPTION OF THE DRAWINGS

The features of the invention will become more apparent in the following detailed description in which reference is made to the appended drawings wherein:

FIG. 1 is a schematic showing compression to flatten a capillary tube as described in Example 1.

FIG. 2 shows a capillary tube as described in Example 1 with ferrules and nuts installed.

FIG. 3 shows an EDS image of untreated PDMS material inside a capillary column with 4 selected areas identified.

FIG. 4 shows a graphical representation of the EDS data collected for area 1 shown in FIG. 3.

FIG. 5 shows a graphical representation of the EDS data collected for area 2 shown in FIG. 3.

FIG. 6 shows a graphical representation of the EDS data collected for area 3 shown in FIG. 3.

FIG. 7 shows a graphical representation of the EDS data collected for area 4 shown in FIG. 3.

FIG. 8 shows an EDS image of thermally treated PDMS material inside a capillary column with 3 selected areas identified.

FIG. 9 shows a graphical representation of the EDS data collected for area 1 shown in FIG. 8.

FIG. 10 shows a graphical representation of the EDS data collected for area 2 shown in FIG. 8.

FIG. 11 shows a graphical representation of the EDS data collected or area 3 shown in FIG. 8.

FIG. 12A is a graph showing XPS data for carbon for a first sample of untreated material.

FIG. 12 B is a graph showing XPS data for carbon for a first sample of thermally treated material.

FIG. 13A is a graph showing XPS data for carbon for a second sample of untreated material.

FIG. 13 B is a graph showing XPS data for carbon for a second sample of thermally treated material.

FIG. 14A is a graph showing XPS data for carbon for a third sample of untreated material.

FIG. 14 B is a graph showing XPS data for carbon for a third sample of thermally treated material.

FIG. 15A is a graph showing XPS data for carbon for a fourth sample of untreated material.

FIG. 15 B is a graph showing XPS data for carbon for a fourth sample of thermally treated material.

FIG. 16A is a graph showing XPS data for oxygen for a first sample of untreated material.

FIG. 16 B is a graph showing XPS data for oxygen for a first sample of thermally treated material.

FIG. 17A is a graph showing XPS data for oxygen for a second sample of untreated material.

FIG. 17 B is a graph showing XPS data for oxygen for a second sample of thermally treated material.

FIG. 18A is a graph showing XPS data for oxygen for a third sample of untreated material.

FIG. 18 B is a graph showing XPS data for oxygen for a third sample of thermally treated material.

FIG. 19 A is a graph showing XPS data for oxygen for a fourth sample of untreated material.

FIG. 19 B is a graph showing XPS data for oxygen for a fourth sample of thermally treated material.

FIG. 20 A is a graph showing XPS data for silicon for a first sample of untreated material.

FIG. 20 B is a graph showing XPS data for silicon for a first sample of thermally treated material.

FIG. 21 A is a graph showing XPS data for silicon for a second sample of untreated material.

FIG. 21 B is a graph showing XPS data for silicon for a second sample of thermally treated material.

FIG. 22 A is a graph showing XPS data for silicon for a third sample of untreated material.

FIG. 22 B is a graph showing XPS data for silicon for a third sample of thermally treated material.

FIG. 23 A is a graph showing XPS data for silicon for a fourth sample of untreated material.

FIG. 23 B is a graph showing XPS data for silicon for a fourth sample of thermally treated material.

FIG. 24 A shows a SEM image of a lengthwise cross section of a capillary tube containing untreated PDMS.

FIG. 24 B also shows a SEM image of a lengthwise cross section of a capillary tube containing untreated PDMS.

FIG. 25 A shows a SEM image of a lengthwise cross section of a capillary containing thermally treated PDMS.

FIG. 25 B shows a SEM image of a lengthwise cross section of a capillary containing thermally treated PDMS.

FIG. 26 A is a higher magnification image of the thermally treated material of FIGS. 25A and B, showing nanoparticulate structure of the material.

FIG. 26 B is a higher magnification image of the thermally treated material of FIGS. 25A and B, showing nanoparticulate structure of the material.

FIG. 27 A shows a SEM image of a cross section of the width of a capillary tube containing untreated PDMS.

FIG. 27 B shows a SEM image of a cross section of the width of a capillary tube containing untreated PDMS.

FIG. 28 A is a higher magnification image of the material shown in FIGS. 27 A and B.

FIG. 28 B is a higher magnification image of the material shown in FIGS. 27 A and B.

FIG. 29 A shows a SEM image of a cross section of the width of a flattened capillary tube containing thermally treated PDMS.

FIG. 29 B shows a SEM image of a cross section of the width of a flattened capillary tube containing thermally treated PDMS.

FIG. 30 A is a higher magnification image of the material shown in FIGS. 29 A and B.

FIG. 30 B is a higher magnification image of the material shown in FIGS. 29 A and B.

FIG. 31 is a higher magnification image of the material shown in FIGS. 29 A and B.

FIG. 32 A is a 2D graphical representations of the results of a 2 dimensional GC analysis using an MXT™-1 capillary column with 1 μm stationary phase film thickness and 0.28 mm internal column diameter as the modulator where the column has been thermally treated

FIG. 32 B is a 3D graphical representations of the results of a 2 dimensional GC analysis using an MXT™-1 capillary column with 1 μm stationary phase film thickness and 0.28 mm internal column diameter as the modulator where the column has been thermally treated

FIG. 32 C is a 2D graphical representations of the results of 2-dimensional GC analysis (of the same sample as used in the analysis of FIGS. 32 A and B) using an MXT™-1 capillary column with 1 μm stationary phase film thickness and 0.28 mm internal column diameter as the modulator where the column is untreated

FIG. 32 D is a 3D graphical representations of the results of 2-dimensional GC analysis (of the same sample as used in the analysis of FIGS. 32 A and B) using an MXT™-1 capillary column with 1 μm stationary phase film thickness and 0.28 mm internal column diameter as the modulator where the column is untreated

FIG. 33 A is a 2D graph showing results of 2D GC analysis using MXT-1 capillary column with 1.5 μm stationary phase film thickness and 0.28 mm internal column diameter as the modulator where the column has been thermally treated.

FIG. 33 B is a 3D graph showing results of 2D GC analysis using MXT-1 capillary column with 1.5 μm stationary phase film thickness and 0.28 mm internal column diameter as the modulator where the column has been thermally treated.

FIG. 33C is a 2D graph showing results of 2D GC analysis (of the same sample as used in the analysis of FIGS. 33 A and B) using MXT-1 capillary column with 1.5 μm stationary phase film thickness and 0.28 mm internal column diameter as the modulator where the column is untreated.

FIG. 33 D is a 3D graph showing results of 2D GC analysis (of the same sample as used in the analysis of FIGS. 33 A and B) using MXT-1 capillary column with 1.5 μm stationary phase film thickness and 0.28 mm internal column diameter as the modulator where the column is untreated.

FIG. 34 A is a 2D graph showing results of 2D GC analysis using MXT-1 capillary column with 0.25 μm stationary phase film thickness and 0.25 mm internal column diameter as the modulator where the column is thermally treated.

FIG. 34 B is a 3D graphs showing results of 2D GC analysis using MXT-1 capillary column with 0.25 μm stationary phase film thickness and 0.25 mm internal column diameter as the modulator where the column is thermally treated.

FIG. 34 C is a 2D graphs showing results of 2D GC analysis (of the same sample as used in the analysis of FIGS. 34 A and B) using MXT-1 capillary column with 0.25 μm stationary phase film thickness and 0.25 mm internal column diameter as the modulator where the column is untreated.

FIG. 34 D is a 3D representation of the graph of FIG. 34 C.

FIG. 35 A is a graph showing results of 2D GC analysis using MXT-1 capillary column with 0.1 μm stationary phase film thickness and 0.25 mm internal column diameter as the modulator where the column is thermally treated.

FIG. 35 B is a 3D graphical representation of FIG. 35 A.

FIG. 35 C is a graph showing results of 2D GC analysis (of the same sample as used in the analysis of FIG. 35 A) using MXT-1 capillary column with 0.1 μm stationary phase film thickness and 0.25 mm internal column diameter as the modulator where the column is untreated.

FIG. 35 D is a 3D graphical representation of FIG. 35 C.

FIG. 36 A is a graph showing results of 2D GC analysis using MXT-35 capillary column with 1 μm stationary phase film thickness and 0.25 mm internal column diameter as the modulator where the column is thermally treated

FIG. 36 B is a 3D representation of the graph of FIG. 36A.

FIG. 36 C is a graph showing results of 2D GC analysis (of the same sample as used in the analysis of FIG. 36 A) using MXT-35 capillary column with 1 μm stationary phase film thickness and 0.25 mm internal column diameter as the modulator where the column is untreated.

FIG. 36 D is a 3D graphical representation of FIG. 36 C.

FIG. 37 A is a graph showing results of 2D GC analysis using MXT-200 capillary column with 1 μm stationary phase film thickness and 0.25 mm internal column diameter as the modulator where the column is thermally treated.

FIG. 37 B is a 3D graphical representation of FIG. 37 A.

FIG. 37 C is a graph showing results of 2D GC analysis (of the same sample used in the analysis of FIG. 37 A) using MXT-200 capillary column with 1 μm stationary phase film thickness and 0.25 mm internal column diameter as the modulator where the column is untreated.

FIG. 37 D is a 3D graphical representation of the graph of FIG. 37 C.

FIG. 38 is a graph showing the average peak areas for various alkane chain lengths separated by 2D GC using a variety of capillary columns as the modulator.

FIG. 39 shows the 1D retention times for various alkane chain lengths using a variety of capillary columns as the modulator.

FIG. 40 shows the 2D retention times for various alkane chain lengths using a variety of capillary columns as the modulator.

FIG. 41 is an EDS image of untreated MXT-1 capillary column showing 3 sample areas.

FIG. 42 is an EDS image of treated MXT-1 capillary column showing 3 sample areas.

FIG. 43 is an EDS image of treated MXT-1 capillary column showing 3 sample areas.

FIG. 44 is an EDS image of treated MXT-1 capillary column showing 4 sample areas.

FIG. 45 is an EDS image of treated MXT-1 capillary column showing 4 sample areas.

FIG. 46 is an EDS image of treated PDMS in a fused silica column showing 1 sample area.

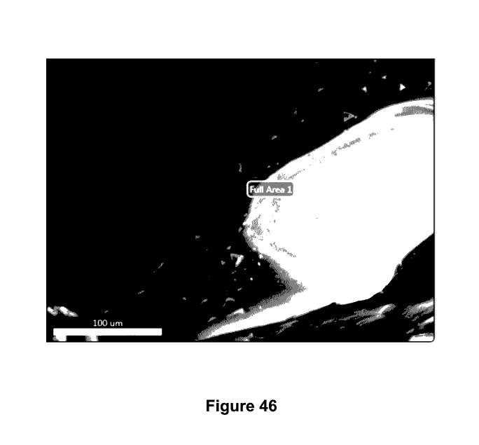

FIG. 47 is a graphical representation of the data EDS data collected for area 1.

### DETAILED DESCRIPTION OF THE INVENTION

Embodiments of the invention will now be described with reference to the figures.

In one aspect of the invention it has been found that a new material can be produced by thermal modification of polymeric organosilicon compounds and in particular, by thermal modification of PDMS or PDMS derivatives. In a further aspect the material formed by thermal modification of PDMS is a sorbent material.

In a further aspect, the material formed by thermal modification of PDMS or a PDMS derivative is a particulate material. In still a further aspect the material is in the form of nanoparticles. In one embodiment the nanoparticles have a size range of about 50 nm to about 1000 nm in a further embodiment the particles measure approximately 500 nm in diameter.

It has been found that thermal modification of PDMS or PDMS derivative which is bound to a substrate can form a sorbent material. Suitable substrates may include metal substrates such as steel or other heat resistant substrates such as fused silica. In a further aspect, it has been found that the PDMS may be bound directly to the substrate or may be bound through an intermediate layer to the substrate. In one example, the PDMS may be bound to steel coated with a silica layer. In a particular example the coating is a hydrogenated amorphous silicon coating. In still a further example, the substrate may take the form of a fiber or a tube. In a particular example the tube may be a capillary tube. The material may be bound to an inner or outer surface of the substrate, for example, the material may be bound to the outer surface of a fiber or the inner surface of a tube.

In another aspect, the thermal modification of PDMS or PDMS derivative to produce a sorbent material is carried out in the presence of oxygen. In one example the oxygen may be delivered in the form of pressurized gas containing oxygen (such as air) blown over the surface of the PDMS during thermal modification.

In yet another aspect the thermal modification can be carried out by intermittent heat treatment. In a particular aspect the intermittent heat treatment may comprise rapid heating to a high temperature followed by rapid cooling. Various heat sources can be employed to carry out the thermal modification of the PDMS or PDMS derivatives such as an oven or furnace, hot air jets, microwaves, lasers, IR radiation, resistive heating and the like. In a particular example, the intermittent heating may be carried out by resistive heating applied to the substrate carrying the PDMS or PDMS derivative. In another aspect the thermal modification is carried out at a temperature of above about 400° C. In a further embodiment the temperature is about 400° C. to about 1000° C., in a further aspect the temperature is about 500° C. to about 900° C., in a further aspect the temperature is about 700° C. to about 850° C. In still a further aspect the temperature is about 750° C. to about 800° C.

In a further aspect intermittent heating can be carried out in one or more heating intervals or cycles. For example there may be 1-5 heating cycles. The heating cycles may be range in duration for examples from about 2 minutes to about 15 minutes more specifically cycles may be 2, 4, 5, 7, or 10 minutes. Longer heating cycles such as 20 min, 30 min or 1 hr may also be possible. Short heating pulses within the heating cycle may also be used where in heat such a resistive heating is applied in short pulses of one to a few seconds. These pulses may be applied repeatedly over the duration of a heating cycle. For example resistive heating pulses may be applied every 6 seconds for the duration of a cycle. In one example intermittent heating to a temperature above 400° C. for five minutes is carried out in two or more intervals.

The modified PDMS material produced by thermal degradation can be used for various applications including but not limited to, as a sorbent for separations or extractions. Further examples of such uses include use as a column stationary phase for GC, liquid chromatography (LC), high performance liquid chromatography (HPLC) or SFC separation columns or as a modulator (trap) for use between separation columns for example in 2-dimensional GC, or as a coating for extractions such as solid phase extraction (SPE) or solid phase microextration (SPME).

One example of a use of the thermally modified polymeric organosilicon material is for a single stage thermal modulation device developed for use in two-dimensional gas chromatography analysis. The device comprises an electrically conductive capillary connected between the primary and the secondary column of a comprehensive two dimensional gas chromatography system. This electrically conductive capillary is positioned such that contact is made between the capillary's external walls and electrically insulating, but heat-conducting material (e.g. machinable ceramics). The electrically insulating material serves to transfer heat away from the electrically conductive capillary contained within the gas chromatography oven through a thermal conduit. This heat transfer system maintains the electrically conductive capillary at a temperature cooler than that of the GC oven throughout the analysis. Modulation is performed through resistive heating of the electrically conductive capillary. This heating mobilizes analytes retained within the coating of the electrically conductive capillary into the carrier gas, and onto the secondary column for further separation. Due to the direct contact with the cooled electrically insulating material, the electrically conductive capillary rapidly cools down after the heating pulse, effectively preventing breakthrough of analytes.

This modulation system does not use liquid nitrogen but rather uses heat conducting material to drive heat away from the modulator and trap the effluent collected from the first column. By avoiding the use of liquid nitrogen the running costs of this system are drastically reduced.

Due to the thermal principles on which this system operates, any carrier gas flow rate may be used. This allows the system to pair very easily with various detection modes including mass spectrometry.

Due to the significant increase in peak amplitude of compounds eluting from the secondary column caused by band focusing in the thermal modulator, much less sample can be used with this system when paired with a mass spectrometer as compared to standard one-dimensional GC and non-trapping modulators.

In this modulator system, heating is accomplished via direct resistive heating of the trap, whereas cooling occurs by heat transfer to the cooling pads that are in direct contact with the trap. Direct heat transfer during both heating and cooling is a factor that results in highly reproducible chromatographic results.

The electrically conductive capillary can be prepared by modification of commercially available capillary columns.

MTX™-1 columns are one example of commercially available capillary columns. These columns are Silicosteel®-lined stainless steel GC capillary columns coated with a 100% dimethylpolysiloxane stationary phase. These commercially available columns are known to exhibit low bleed and high maximum operating temperatures for e.g. 445° C. under typical GC conditions. MXT™-1 columns are made from Silicosteel™ treated stainless steel. The Silicosteel process bonds a thin flexible layer to the stainless steel surface which offers comparably efficiency and inertness to fused silica tubing with increased durability.

Columns having a fused silica tubing and PDMS internal coating are also commercially available. For example, Rtx™-1 columns are made with polyimide coated fused silica tubing and deactivated with a non-polar deactivation layer resulting in a high degree of tubing inertness. These columns are known to have a maximum operating temperature of about 350° C. Fused silica tubing may be suspended within a steel frame which may provide protection to the capillary tube.

In some examples of commercial capillary columns the dimethylpolysiloxane stationary phase is processed to form a highly crosslinked polymer lattice which bonds the polymer to the fused silica inner surface of the tube.

In an embodiment of the present invention commercially available capillary columns are treated to modify the composition of the internal stationary phase. They may be further treated to modify the internal geometry.

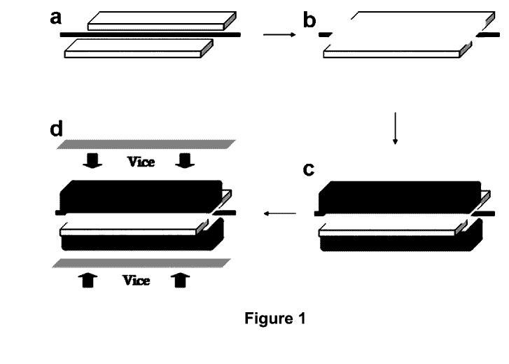

To modify the internal geometry, the capillary column is compressed to flatten, or create an oval shaped cross section as shown in FIG. 1.

The internal stationary phase is modified by thermal treatment. In one embodiment the internal stationary phase may be modified by applying electrical current to a conductive capillary column.

The modulator trap may be prepared from a conductive capillary column, such as a steel capillary or fused silica capillary column. The capillary column is coated internally with a polymeric organosilicon stationary phase. Examples of polymeric organosilicon compounds include polydimethylpolysiloxane (PDMS), and derivatives of PDMS such as, substituted polydimethyl siloxanes including (6% cyanopropyl-phenyl) dimethylpolysiloxane, (14% cyanopropyl-phenyl)-dimethylpolysiloxane, (35% diphenyl)-dimethylpolysiloxane, (35% phenyl)-dimethylpolysiloxane, (35%-trifluoropropyl)-dimethylpolysiloxane.methylpolysiloxane, (5% diphenyl)-dimethylpolysiloxane, (5% phenyl)-dimethylpolysiloxane, arylene/methyl modified polysiloxane, (20% diphenyl)-dimethylpolysiloxane, (50% phenyl)-methylpolysiloxane, (50% diphenyl)-dimethylpolysiloxane, (50% phenyl)-dimethylpolysiloxane, (50% cyanopropyl)-phenylmethylpolysiloxane, (90% biscyanopropyl)-cyanopropylphenylpolysiloxane, bicyanopropyl polysiloxane and the like. It will be readily understood by a person of skill in the art that other substitutions of PDMS are possible and also that the percentage of substitution can be easily varied.

The capillary columns of various internal diameters may be used. In a particular embodiment, the capillary column has an interior diameter of 0.28 mm or 0.25 mm.

The length of the capillary may be varied to provide a suitable length for the intended purpose, which may be chosen by a person of skill in the art. In a particular embodiment the column is about 7 cm long.

Mechanical flattening of the capillary can be carried out by a variety of methods. In one embodiment the mechanical flattening is completed as shown in FIG. 1 by placing the tubing between two shims and applying pressure using a vice. The force applied by the vice ensured uniform and precise flattening of the trap along the desired length.

In one embodiment, the outside diameter is decreased from 0.54 mm to an outer wall-to-wall distance of 0.36 mm. This corresponds to an internal diameter (id) reduction from 0.28 mm id to 0.10 mm wall-to-wall distance.

Thermal treatment of the capillary may be done by a variety of methods including heating within an oven or through resistive heating by passing an electrical current through the capillary. In one embodiment the electrical current can be applied intermittently for about 5-30 minutes.

In a further aspect the thermal treatment takes place in the presence of oxygen. More specifically there may be a flow of an oxygen containing gas such as air. In a further embodiment the flow direction of the gas may be changed one or more times for a portion of the current application for example the flow direction may be changed for each heating cycle.

In one embodiment, electrical leads connected to a capacitive discharge device are attached directly to the capillary. An electrical current is then passed through the trap about every 5-10 seconds, preferably about every 6 seconds, for about 5-20 minutes, preferably about 10 minutes (100 pulses). After about 10 minutes the electrical leads are removed from the capillary.

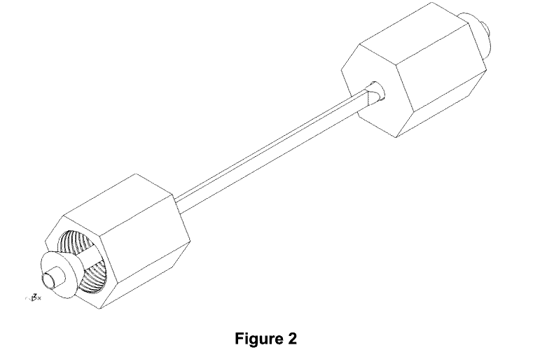

Stainless steel ferrules and nuts are then installed on the capillary as seen in FIG. 2. Once the ferrules and nuts are installed and the capillary trimmed of its excess, the capillary is connected to the leads and undergoes two more thermal treatments. Each treatment is 5 minutes long. Leads are then connected to the steel column connecting nuts. After the first 5 minute treatment, the direction of flow through the trap is reversed. The second 5 minute treatment then proceeds. After the second 5 minute treatment is complete, the trap is removed from the leads.

In a further aspect of the method, gas containing from about 0.5-100% oxygen is blown through the capillary during the treatment with electric current. In one embodiment the gas is compressed air. In a particular embodiment in-line filters are used to purify the gas before it enters the capillary.

The temperature reached at the outside of the capillary during each pulse ranges from approximately 500 to 1300° C. In a further embodiment the temperature of the outside of the capillary column during electrical pulses is approximately 800° C.

In one embodiment the capillary may be modified by treatment with electrical current only. In another embodiment the capillary may be modified by flattening only. In a further embodiment the capillary may be modified by both flattening and treatment with electrical current, which may be done in any order. In a specific example the capillary will be flattened first and then treated with electric current.

An embodiment of the invention will now be described by way of a specific example.

### Example 1a

### Construction of Column

The steel capillary column consists of a 0.28 mm ID steel capillary column coated internally with 1 μm of PDMS. The column is constructed by a two-step process.

Step 1: Flattening

An approximately 7 cm section of 0.28 mm ID steel capillary column is cut from a capillary column. Mechanical flattening of the trapping capillary is then completed as shown in FIG. 1: (a) The tubing (black) was placed between two shims (gray) and was (b) secured in place with masking tape (white). (c) Two parallels were placed on both sides and (d) inserted into a vice. The force applied by the vice ensured uniform and precise flattening of the trap along its entire length. The outside diameter is decreased from 0.54 mm (od) to an outer wall-to-wall distance of 0.36 mm. This corresponds to an internal diameter reduction from 0.28 mm (id) to 0.10 mm wall-to-wall distance. Measurements are taken manually with a micrometer and any deviations >0.01 mm in outer wall-to-wall distance measured in the traps results in column rejection.

Step 2: Thermal Treatment

Upon successful flattening, the 7 cm capillary is connected to compressed air line with in-line filters. Compressed air is turned on and electrical leads connected to a capacitive discharge device are attached directly to the flattened capillary using clips. The distance between the clips is 5 cm. Electrical current is then passed through the flattened section of the trap every 6 seconds for 10 minutes (100 pulses). The temperature reached at the outside of the capillary during each pulse is approximately 800° C. After 10 minutes the capillary is removed from the air supply and the clips are removed. Stainless steel ferrules and nuts are then installed on the capillary as seen in FIG. 2. Once the ferrules and nuts are installed and the capillary trimmed of its excess, the capillary is connected once again to the compressed air line and undergoes two more thermal treatments. Each treatment is 5 minutes long. The clips are in this case connected to the steel column connecting nuts. After the first 5 minute treatment, the trap is detached and the direction of flow through the trap is reversed. The second 5 minute treatment then proceeds. After the second 5 minute treatment is complete, the trap is removed from the air line and construction is complete.

### Example 1b

In this example a fused silica capillary column is used in place of the steel capillary column and exposed to the same thermal treatment as described in step 2 above.

### Example 2

### Chemical Analysis

Upon treatment of the capillary column with electrical current, distinct differences in stationary phase functionality and morphology can be seen. Several analytical techniques have been used to elucidate the chemical composition of modified stationary phase. These include XPS (x-ray photoelectron spectroscopy), SEM (scanning electron microscopy) and EDS (energy dispersive spectroscopy).

EDS Data

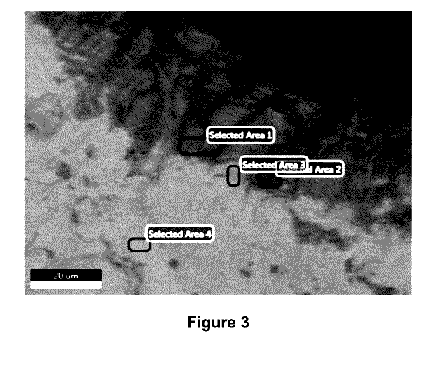

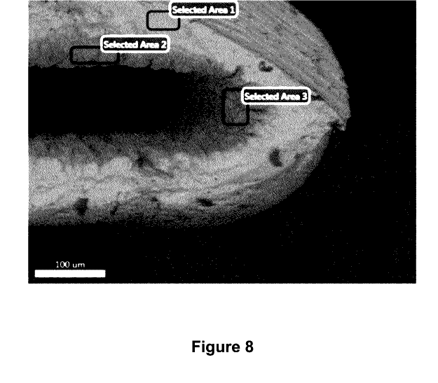

EDS data was collected for 4 selected areas of a non-treated capillary column and 3 selected areas of a capillary column post treatment as described in Example 1. FIG. 3 shows an EDS image of an untreated capillary with the 4 selected areas for EDS data collection identified. FIG. 8 shows an EDS image of a treated capillary with the 3 selected areas for EDS data collection identified.

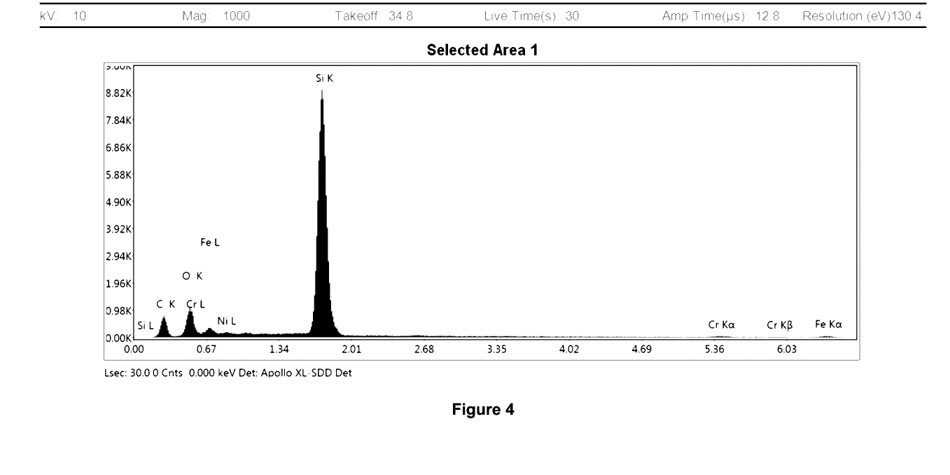

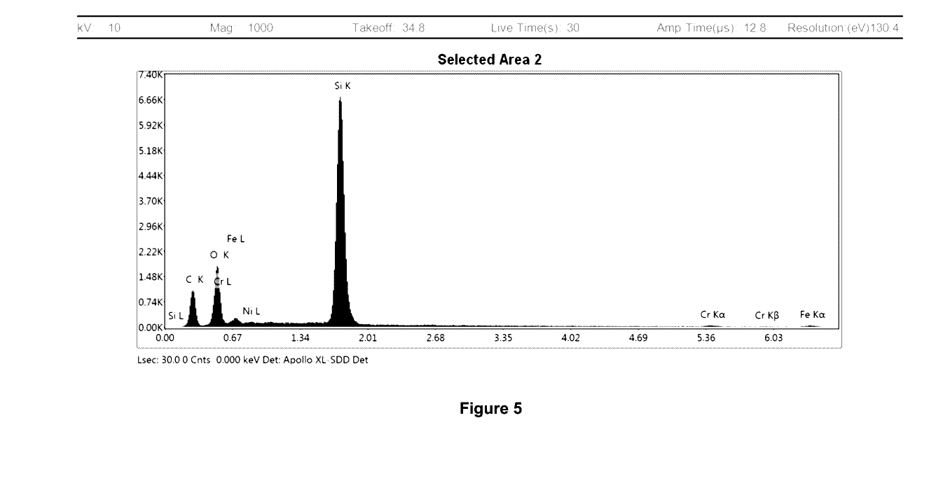

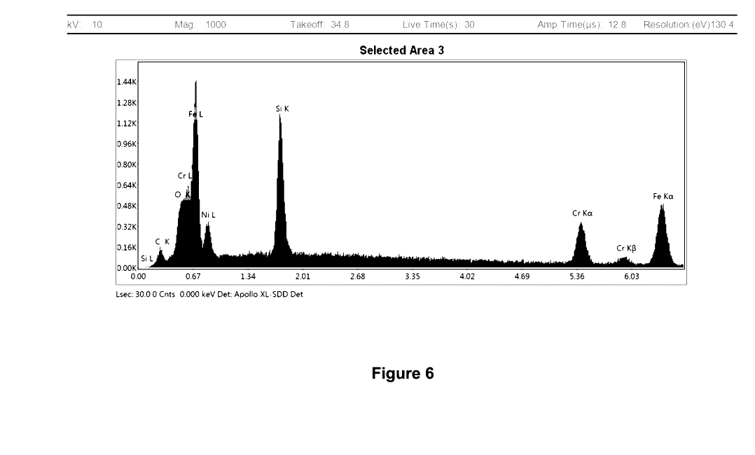

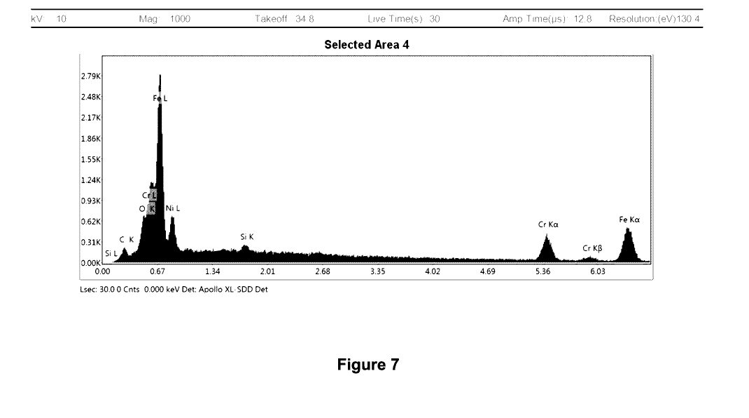

EDS results for areas 1 to 4 of the untreated capillary are shown in tables 1 to 4 below. Graphical representations are provided in FIGS. 4 to 7. Areas 1 and 2 (tables 1 and 2, respectively) represent untreated PDMS stationary phase coating with the expected components being carbon, silicon and oxygen at atomic percentages of 50%, 25% and 25%, respectively. Small amounts of iron, nickel and chromium are likely arising from the steel column material. Areas 3 and 4 (tables 3 and 4, respectively) represent exposed sections of the stainless steel capillary wall. Components iron, nickel, carbon and chromium which are representative of steel are expected to embody the greatest proportion of the atomic percentages. Trace levels of silicon are also present.

TABLE 1

| Element | Weight % | Atomic % | Net Int. | Error % |
|---|---|---|---|---|
| C K | 25.93 | 43.62 | 169.56 | 11.62 |
| O K | 10.07 | 12.73 | 231.4 | 9.13 |
| FeL | 2.56 | 0.93 | 32.6 | 9.57 |
| NIL | 0.36 | 0.12 | 7.16 | 32.74 |
| SiK | 56.99 | 41.01 | 2714.38 | 2.79 |
| CrK | 4.1 | 1.59 | 19.69 | 18.99 |

TABLE 2

| Element | Weight % | Atomic % | Net Int. | Error % |
|---|---|---|---|---|
| C K | 31.85 | 48.67 | 239.13 | 10.88 |
| O K | 17.27 | 19.8 | 376.79 | 8.79 |
| FeL | 2 | 0.66 | 22.35 | 10.04 |
| NiL | 0.23 | 0.07 | 4.1 | 19.72 |
| SiK | 45.36 | 29.64 | 2026.43 | 2.88 |
| Crk | 3.29 | 1.16 | 14.87 | 21.67 |

TABLE 3

| Element | Weight % | Atomic % | Net Int. | Error % |
|---|---|---|---|---|
| C K | 4.62 | 15.92 | 35.77 | 13.55 |
| O K | 1.93 | 4.98 | 47.11 | 11.24 |
| FeL | 38.29 | 28.37 | 233.57 | 7.76 |
| NiL | 5.11 | 3.6 | 35.35 | 19.77 |
| SiK | 10.77 | 15.87 | 292.7 | 6.14 |
| CrK | 39.28 | 31.26 | 142.5 | 7.36 |

TABLE 4

| Element | Weight % | Atomic % | Net Int. | Error % |
|---|---|---|---|---|
| C K | 5.43 | 20.41 | 64.18 | 11.51 |
| O K | 0.61 | 1.73 | 20.44 | 19.23 |
| FeL | 52.99 | 42.88 | 498.4 | 6.48 |
| NiL | 10.84 | 8.35 | 93.08 | 10.18 |
| SiK | 0.6 | 0.97 | 20.95 | 25.47 |
| CrK | 29.52 | 25.66 | 150.75 | 7.69 |

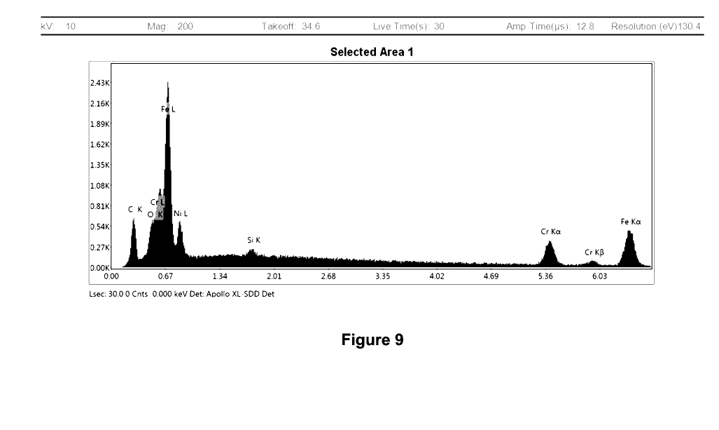

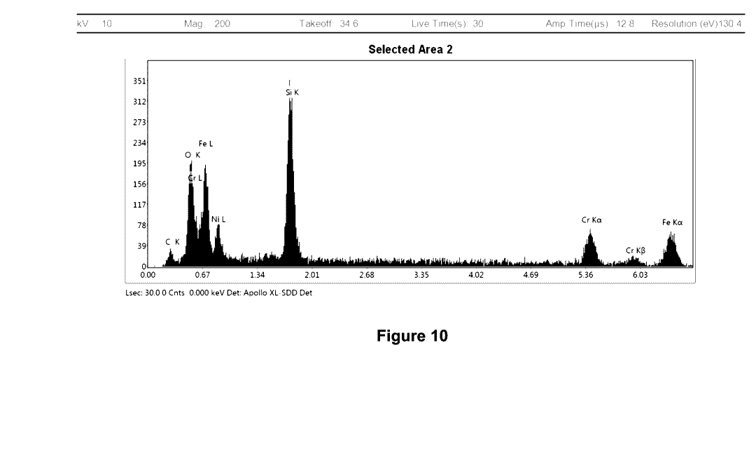

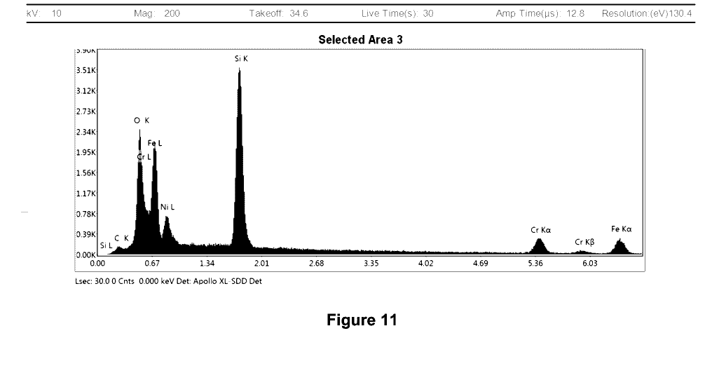

EDS results for areas 1-3 of the treated capillary are shown in tables 5-7 below. Graphical representations are provided in FIGS. 9-11. Area 1 (tables 5) represents exposed sections of the stainless steel capillary wall. Components iron, nickel, carbon and chromium which are representative of steel are expected to embody the greatest proportion of the atomic percentages. Trace levels of silicon and oxygen are also present. Areas 2 and 3 (tables 6 and 7, respectively) represent internal sections of the treated PDMS stationary phase coating. Untreated PDMS has the components carbon, silicon and oxygen at atomic percentages of 50%, 25% and 25%, respectively. Treatment of the PDMS coating modifies the atomic ratio of these components by reducing the amount of carbon and oxygen relative to the amount of silicon present. Since areas 2 and 3 include both treated PDMS as well as exposed sections of steel capillary wall, iron, nickel and chromium are also present in these scans.

TABLE 5

| Element | Weight % | Atomic % | Net Int. | Error % |
|---|---|---|---|---|
| C K | 12.92 | 39.72 | 153.57 | 9.69 |
| O K | 0.78 | 1.79 | 22.31 | 12.28 |
| FeL | 48.4 | 32 | 416.57 | 6.67 |
| NiL | 8.33 | 5.24 | 69.46 | 10.58 |
| SiK | 0.42 | 0.56 | 14.01 | 34.07 |
| CrK | 29.15 | 20.7 | 137.33 | 7.96 |

TABLE 6

| Element | Weight % | Atomic % | Net Int. | Error % |
|---|---|---|---|---|
| C K | 5.07 | 15.34 | 8.02 | 17.41 |
| O K | 6.75 | 15.32 | 35.01 | 9.77 |
| FeL | 23.58 | 15.33 | 28.81 | 10.41 |
| NiL | 6.46 | 3.99 | 10.6 | 17.8 |
| SiK | 15.84 | 20.48 | 94.82 | 6.75 |
| CrK | 42.31 | 29.55 | 31.87 | 10.28 |

TABLE 7

| Element | Weight % | Atomic % | Net Int. | Error % |
|---|---|---|---|---|
| C K | 4.93 | 13.53 | 49.76 | 12.87 |
| O K | 10.84 | 22.36 | 394.04 | 6.94 |
| FeL | 30.26 | 17.88 | 338.28 | 6.59 |
| NiL | 8.26 | 4.64 | 107.12 | 8.68 |
| SiK | 23.31 | 27.38 | 1037.28 | 4.49 |
| CrK | 22.39 | 14.21 | 127.28 | 7.81 |

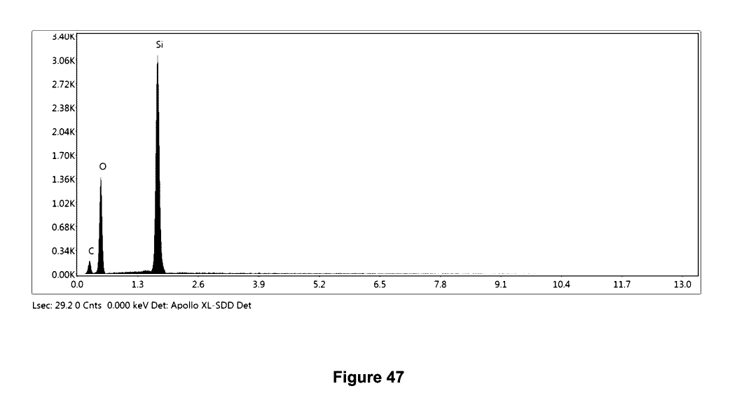

EDS analysis was also carried out on the thermally treated fused silica capillary column of example 1b. Area 1 identified in the EDS image was analyzed and the data is provided in Table 8. A graphical representation of the data is provided in FIG. 47.

TABLE 8

| Element | Weight % | Atomic % | Net Int. | Error % | Kratio | Z | R | A | F |
|---|---|---|---|---|---|---|---|---|---|
| C K | 23.66 | 32.77 | 47.27 | 12.21 | 0.04 | 1.06 | 0.97 | 0.18 | 1 |
| O K | 49.16 | 51.12 | 340.69 | 9.42 | 0.13 | 1.01 | 0.99 | 0.26 | 1 |
| SiK | 27.18 | 16.10 | 978.31 | 3.29 | 0.21 | 0.92 | 1.04 | 0.83 | 1 |

XPS Data

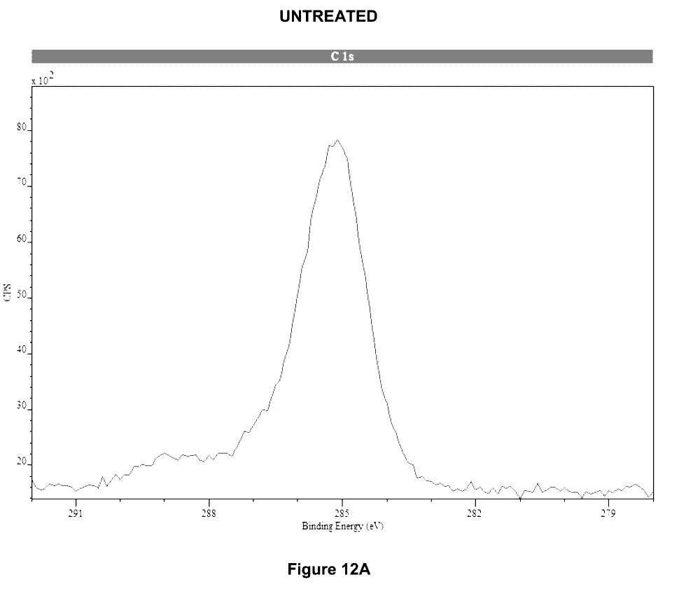

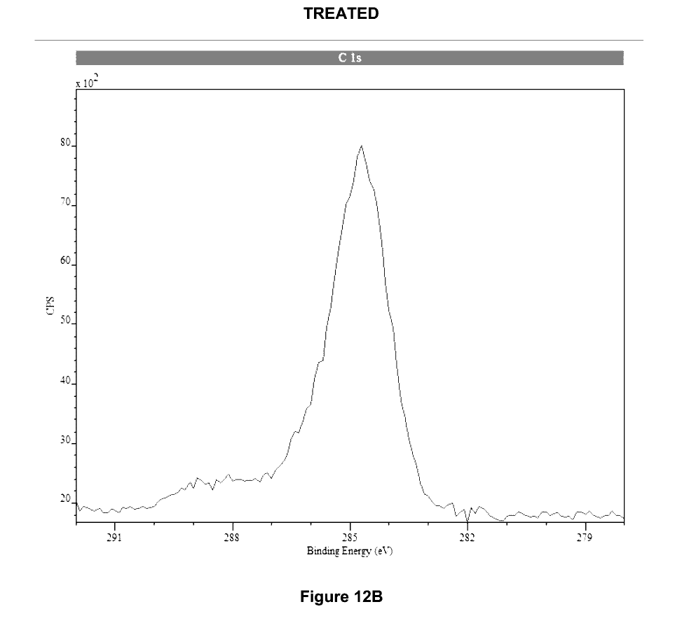

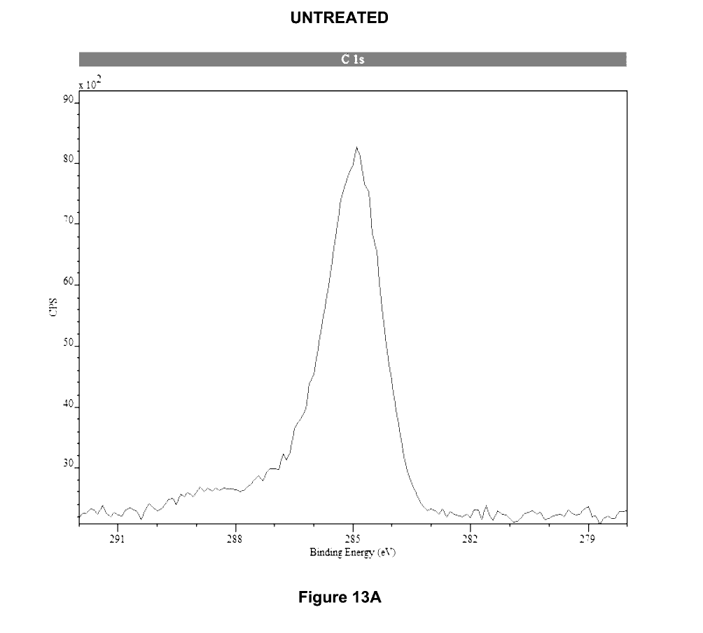

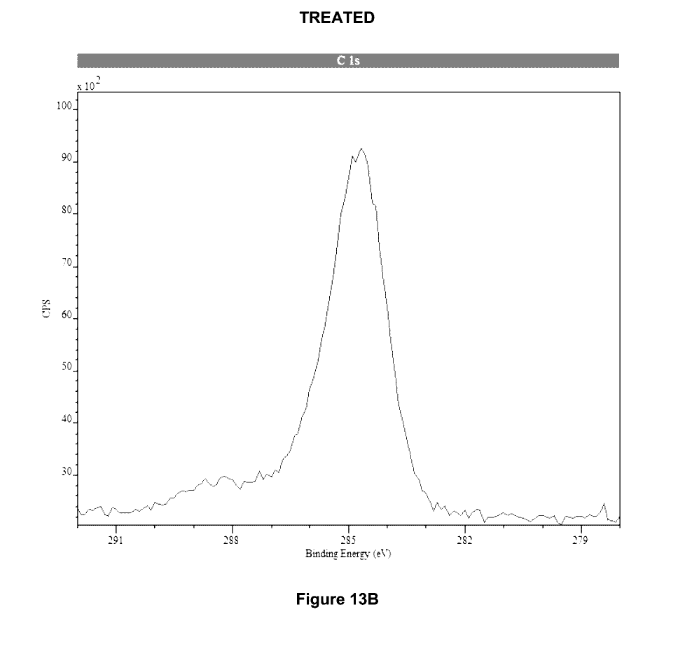

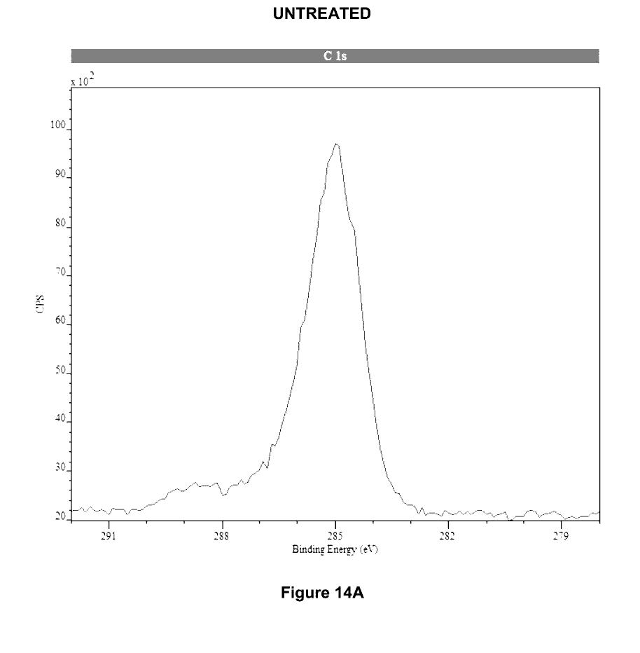

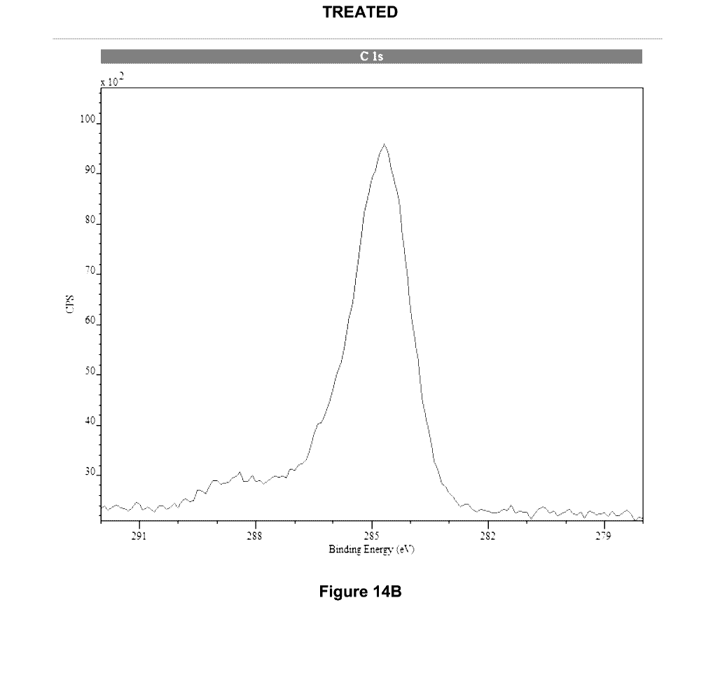

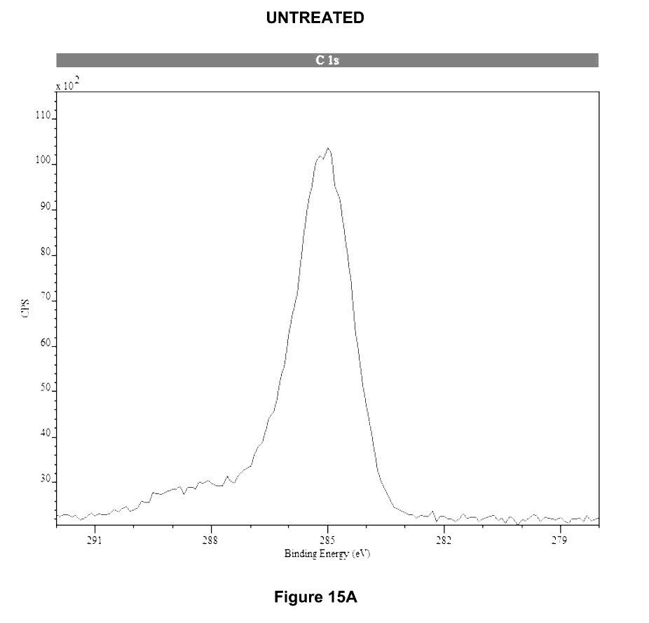

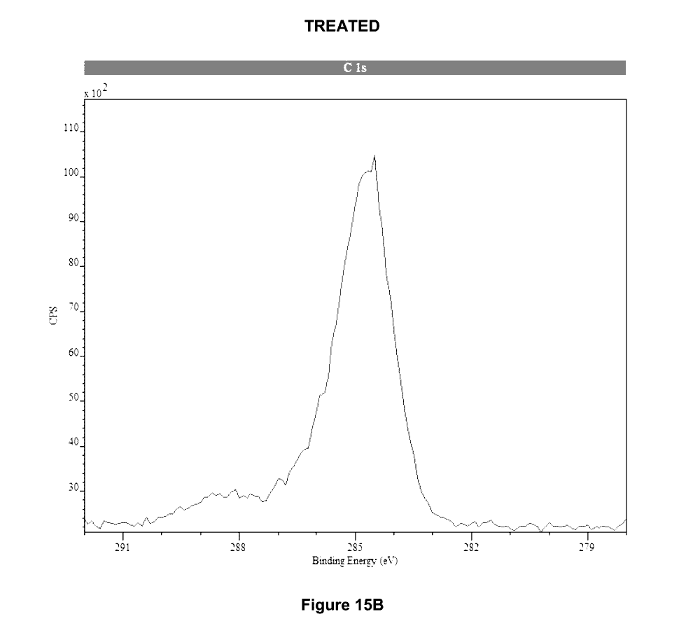

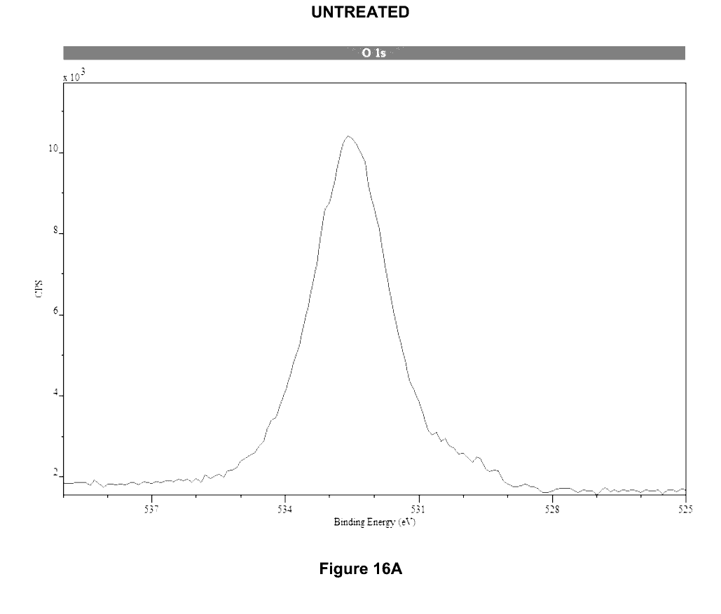

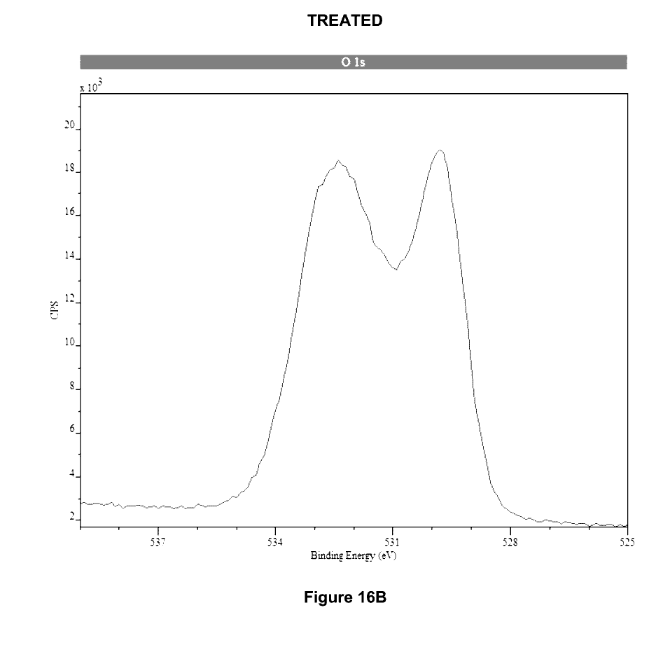

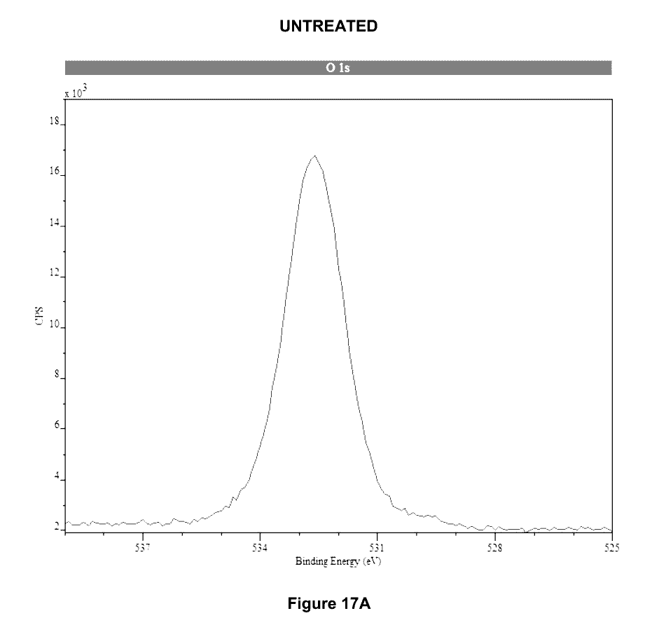

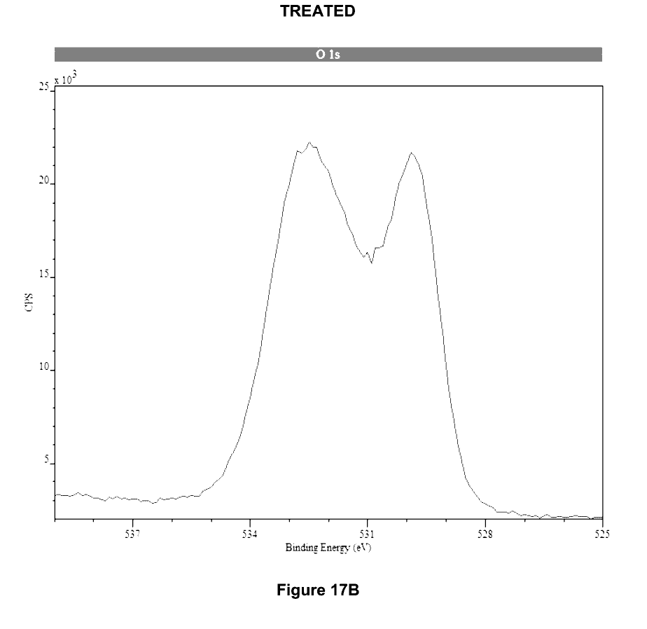

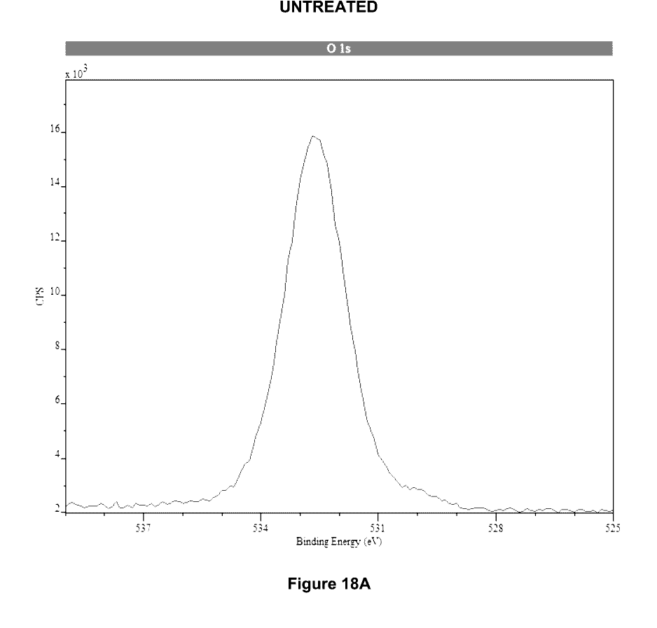

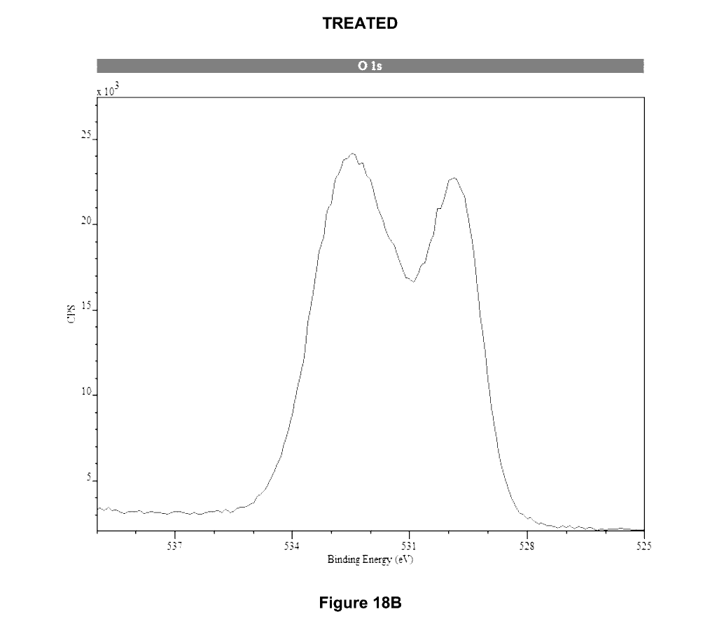

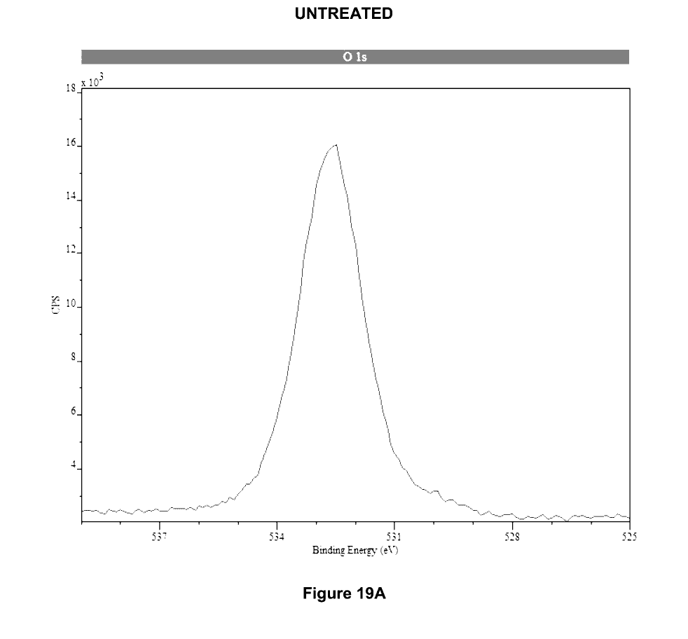

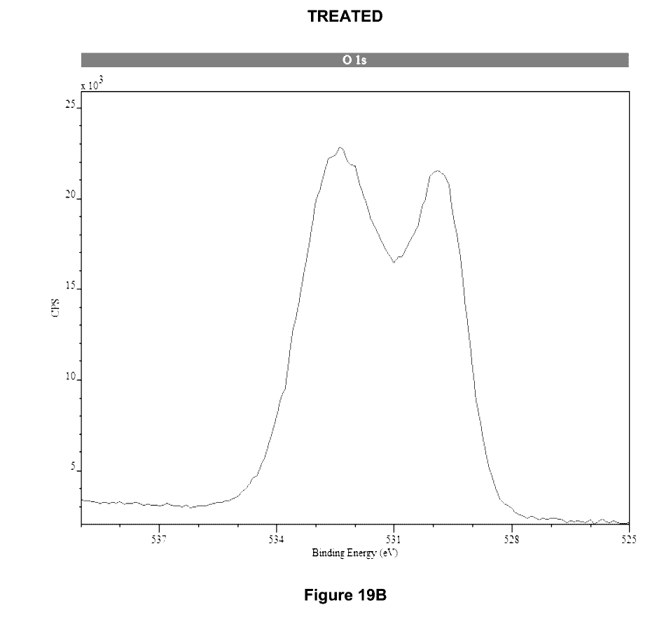

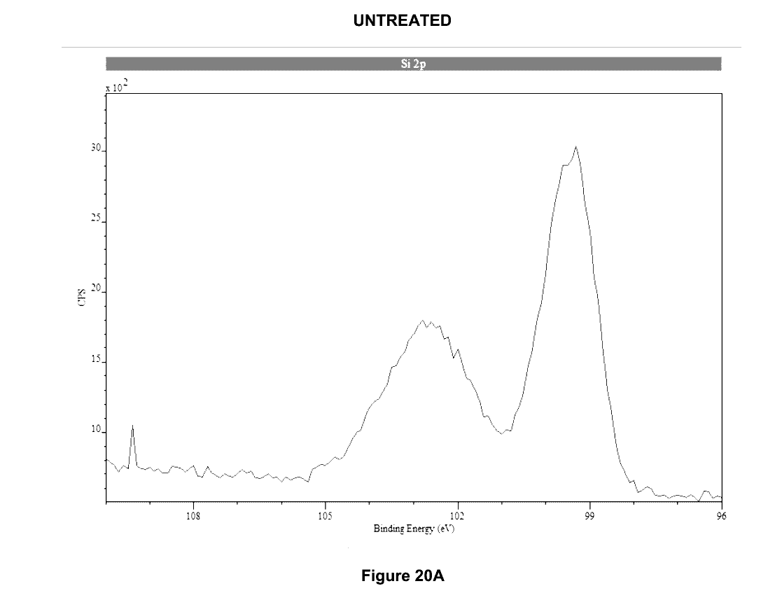

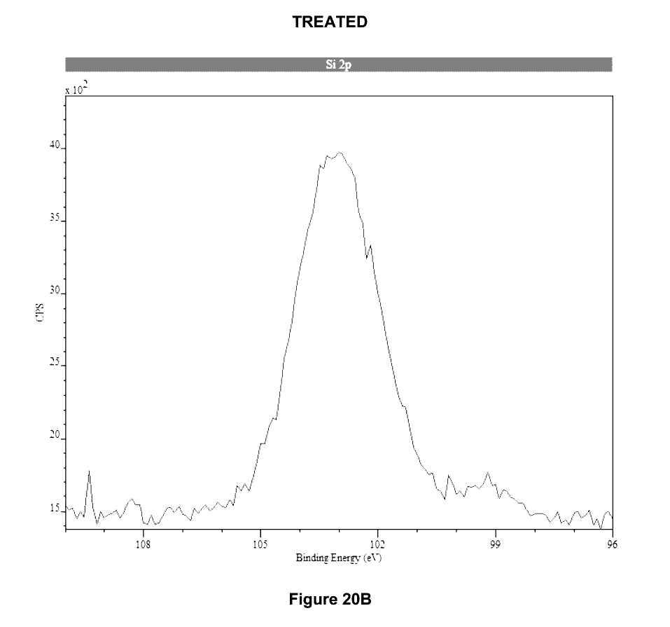

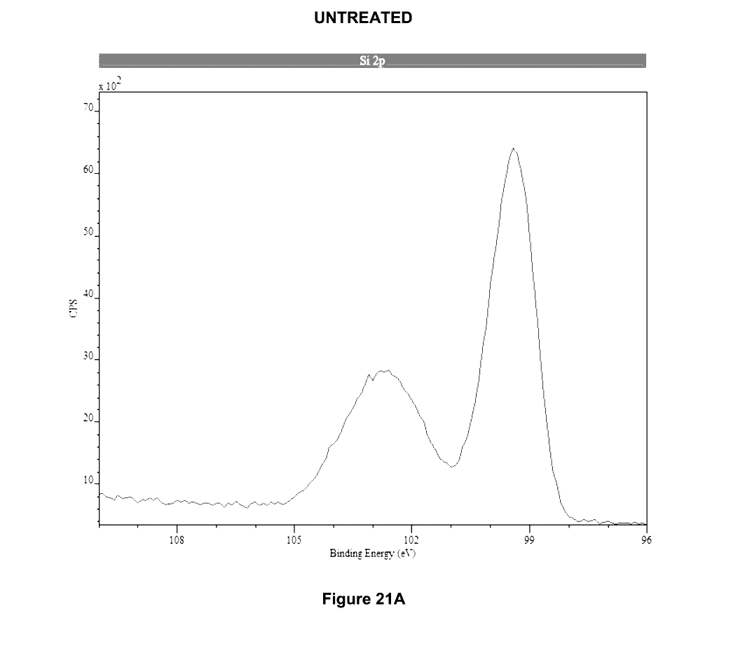

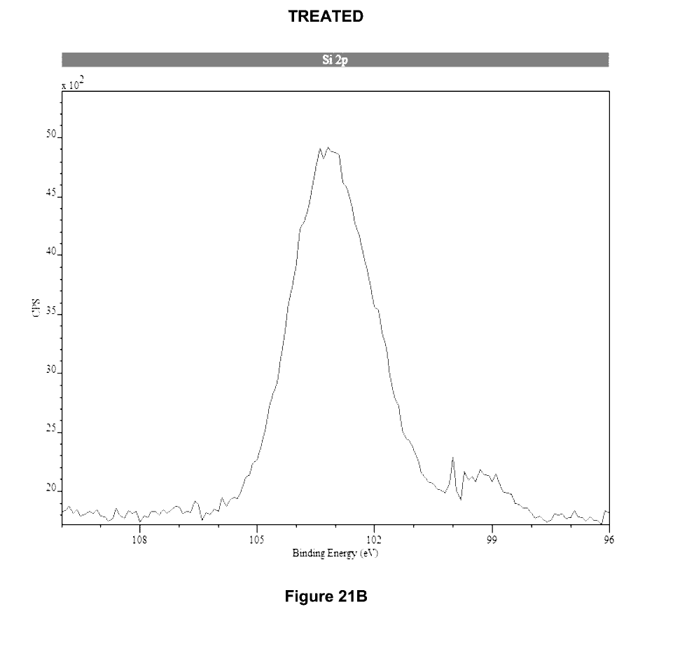

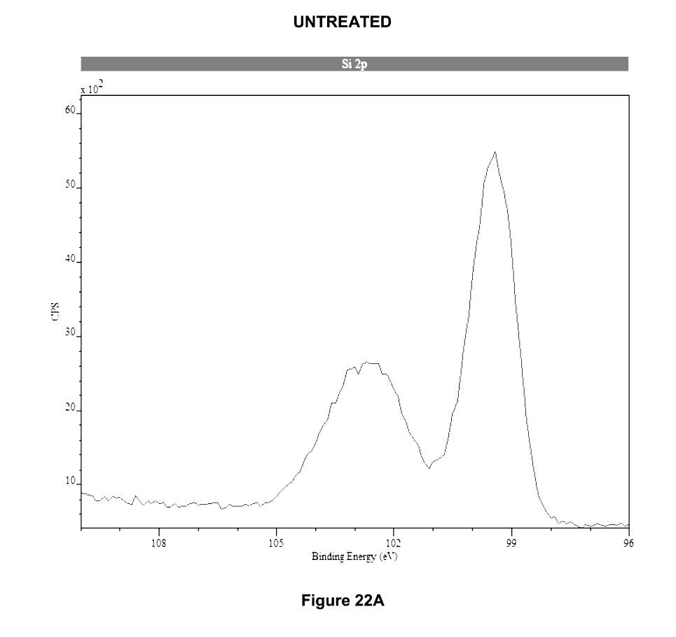

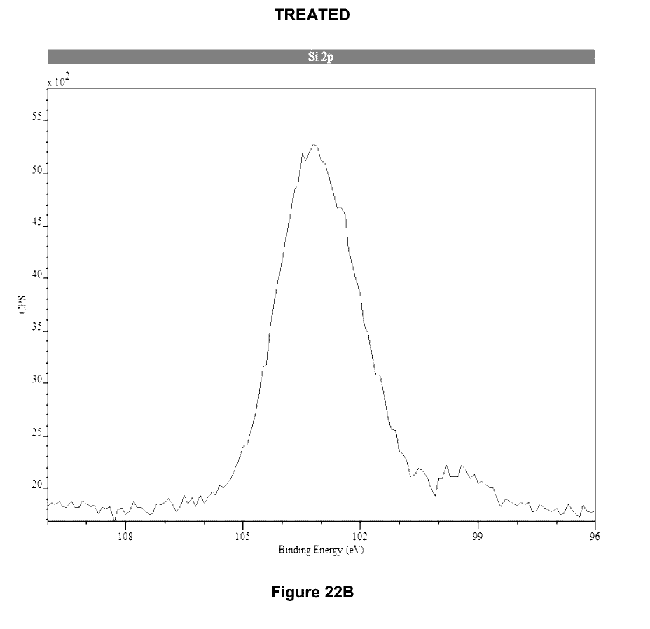

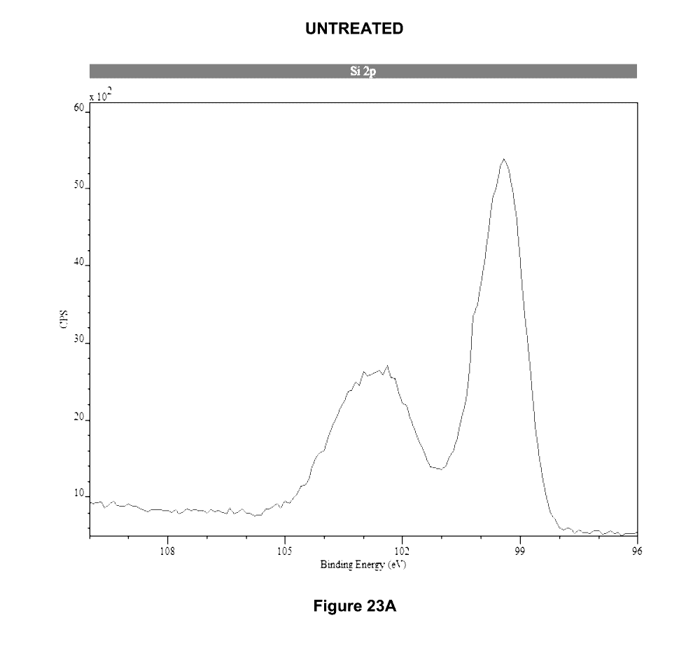

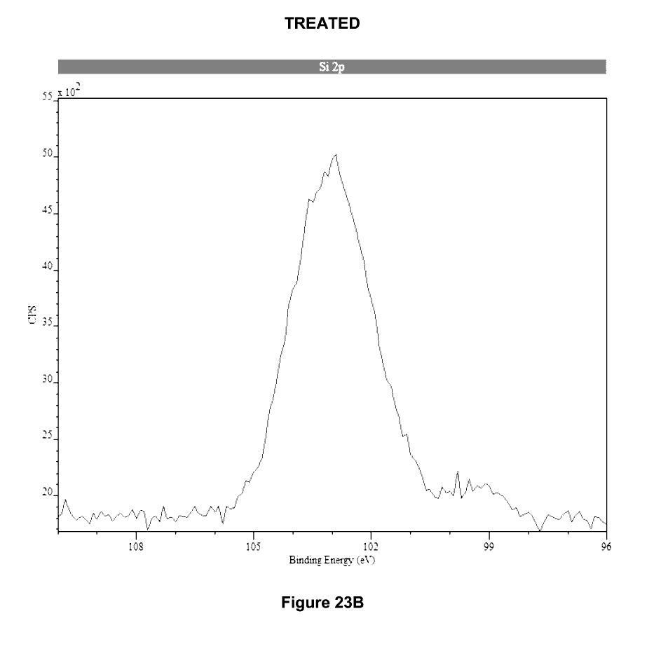

XPS data is provided in FIGS. 12-23. In each figure, figure a) represents the untreated capillary material, while figure b) represents the treated capillary material.

Regarding silicon, in untreated PDMS the Si 2p XPS spectra reveals two peaks. The peak at the lower binding energy, ˜99.4 eV, represents elemental silicon. The peak at the higher binding energy, ˜103.5 eV, represents SiO₂. Upon thermal treatment of the stationary phase, XPS spectra reveal one large peak at binding energy˜103.5 eV and a trace peak at ˜99.4 eV, suggesting nearly all the elemental silicon has been oxidised to SiO2. Regarding Oxygen, in untreated PDMS the O 1s XPS spectra reveal a singular peak at binding energy 533 eV which likely represents SiO2 binding. Upon thermal treatment the original peak at ˜533 eV broadens greatly towards the direction of lower binding energy and is accompanied by a second peak with a binding energy of ˜530 eV. This suggests that oxygen remains in a state of SiO2 but is now accompanied by various metal carbonates and metal oxides arising from the thermally oxidative treatment process applied to exposed sections of steel capillary. Regarding carbon, in untreated PDMS the C 1s XPS spectra reveal one peak at ˜284.8 eV, which likely represents sp3 hybridised carbon binding. Upon thermal treatment the peak shifts to lower bonding energy of ˜284 eV which likely represents less sp3 binding of carbon and greater Si—C binding. In summary the preliminary XPS data suggests that the previously described thermal treatment process modifies PDMS stationary phase coating in to a carbon doped, highly oxidised silica material.

SEM Data

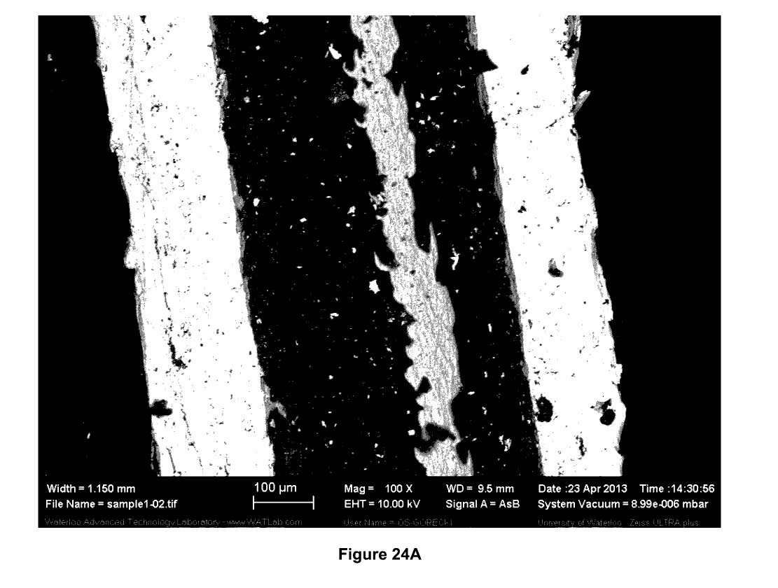

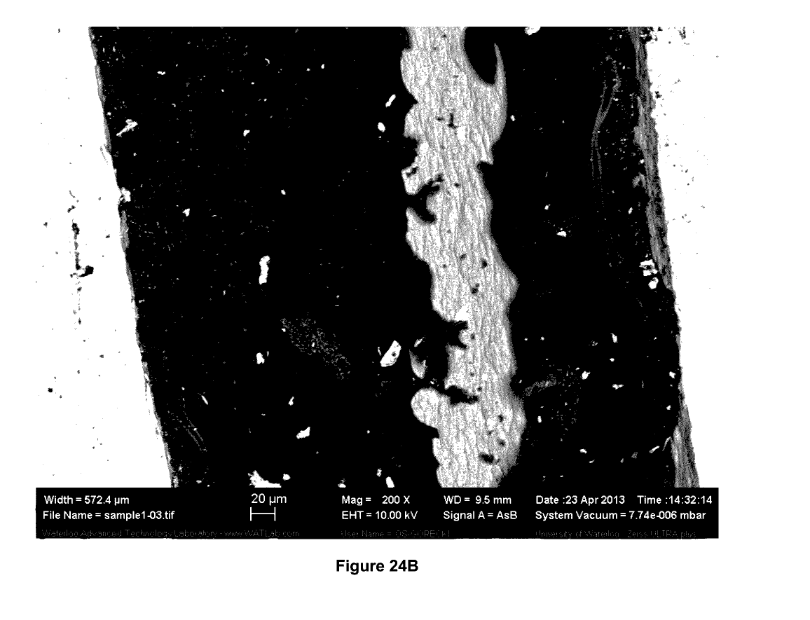

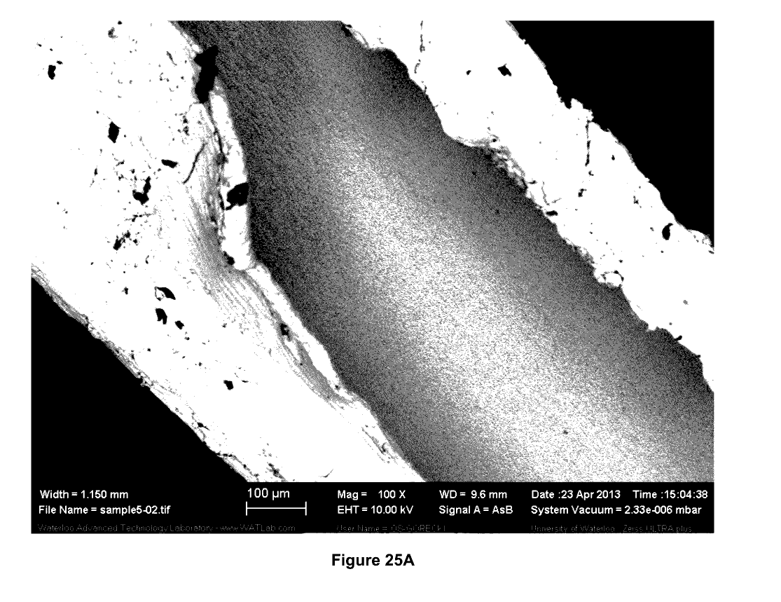

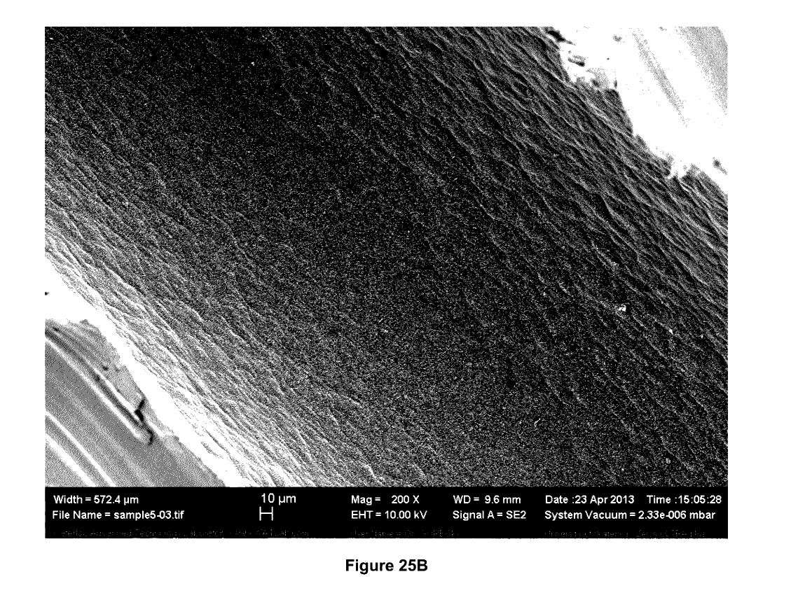

FIGS. 24 a and b show SEM images of the inside of the capillary before treatment, more specifically a cross section along the length of a capillary. FIGS. 25 a and b show SEM images of a cross section along the length of a capillary after treatment. In FIG. 24 a, the light grey layer on the left and right are the steel wall of the capillary, the dark material in between the two walls is PDMS. (The mid grey coloured layer in the centre is a scratch in the PDMS layer which resulted from the instrument used to pry open the capillary to obtain the cross section view.)

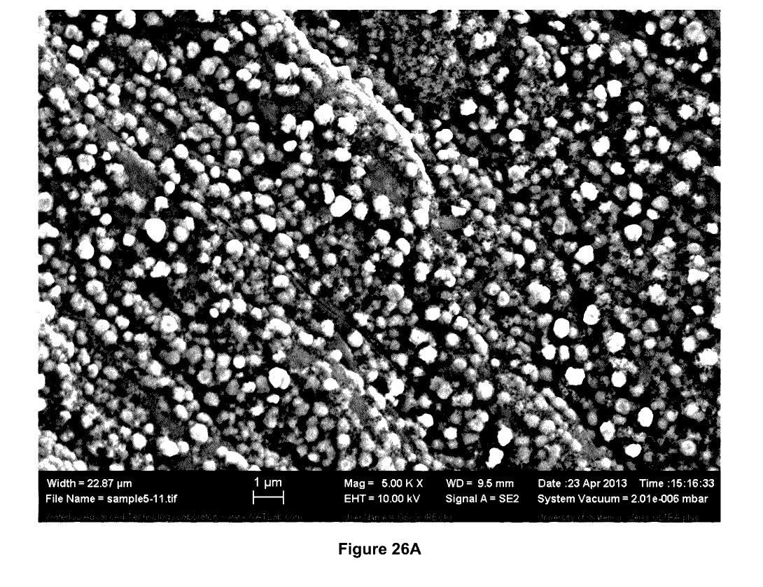

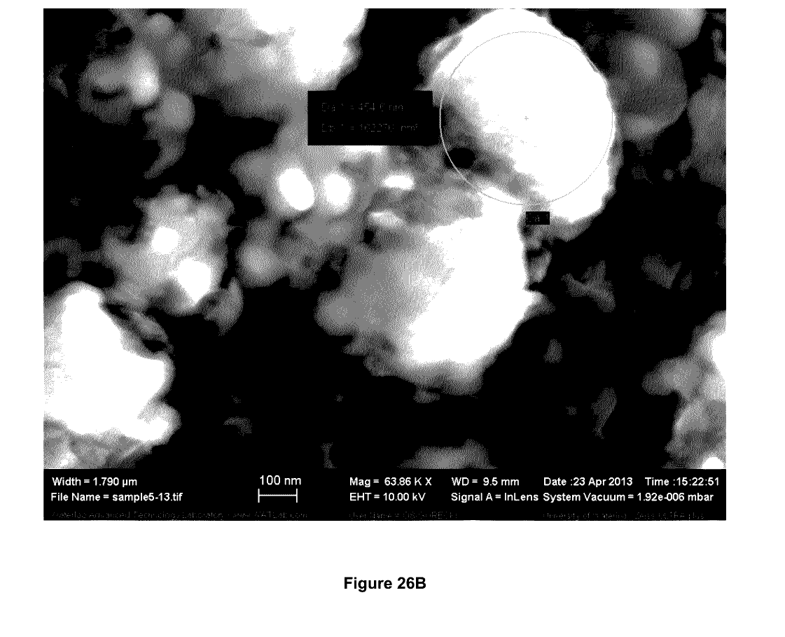

FIGS. 25 a and b show SEM images of the inside of the capillary after treatment. More specifically the image shows a cross section along the length of the capillary. As in FIG. 24, the light coloured material to the upper right and lower left of the image are the outer wall of the capillary, the dark material in the center is the PDMS material after treatment by the method of example 1. It is clear from these images that the treated material has a different physical appearance than the untreated material. FIGS. 26 a and b are higher magnification images showing the capillary internal coating stationary phase material after treatment. These images show that a nano-particulate structure has formed.

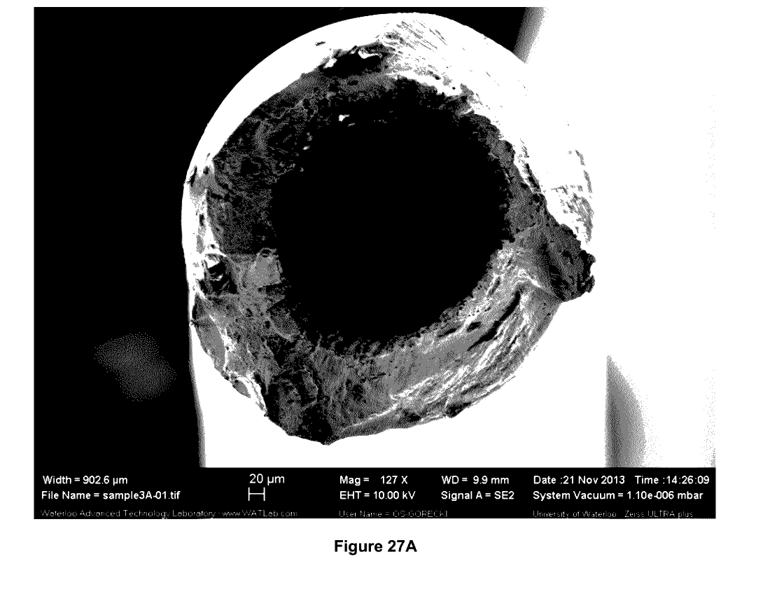

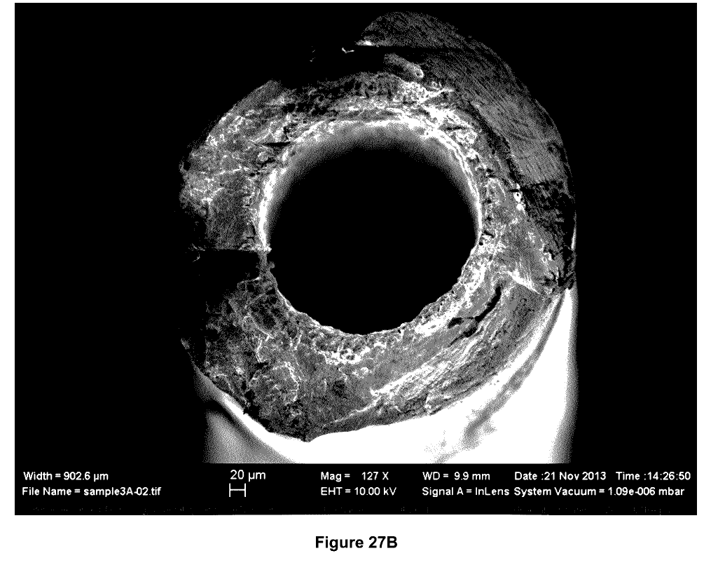

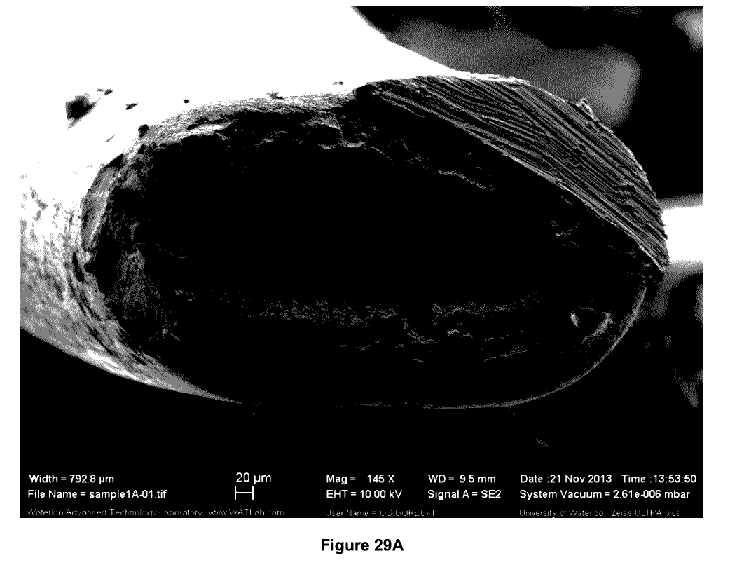

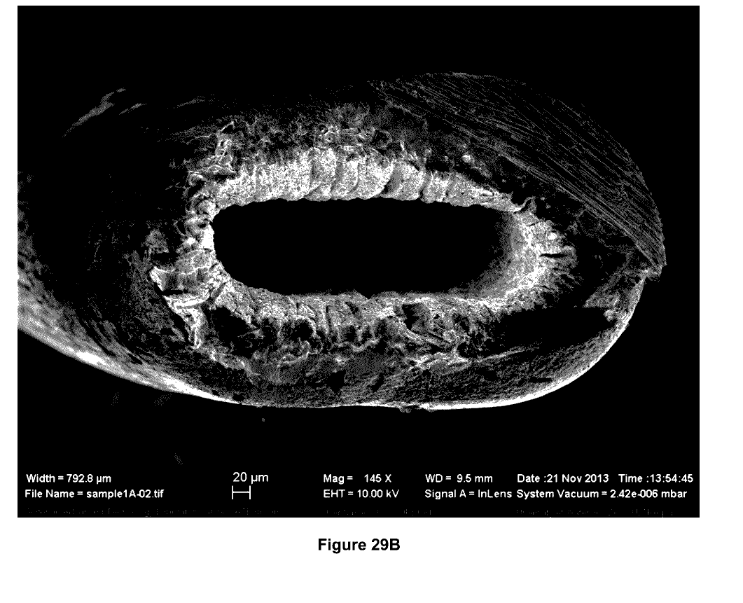

FIGS. 27 a and b show SEM images of a cross sections of the width of a capillary. FIG. 27 a) shows a capillary before treatment and b) shows a capillary after treatment according to step 2 of Example 1 (but not flattening according to step 1). FIGS. 29 a and b also show SEM images of a cross section along the width of a capillary. FIGS. 29 a and b show the capillary after treatment but using different SEM detectors. FIGS. 29 a shows the image obtained with conventional secondary electron detector whereas 29 b shows the image obtained with the in-lens detector which enhances contrast.

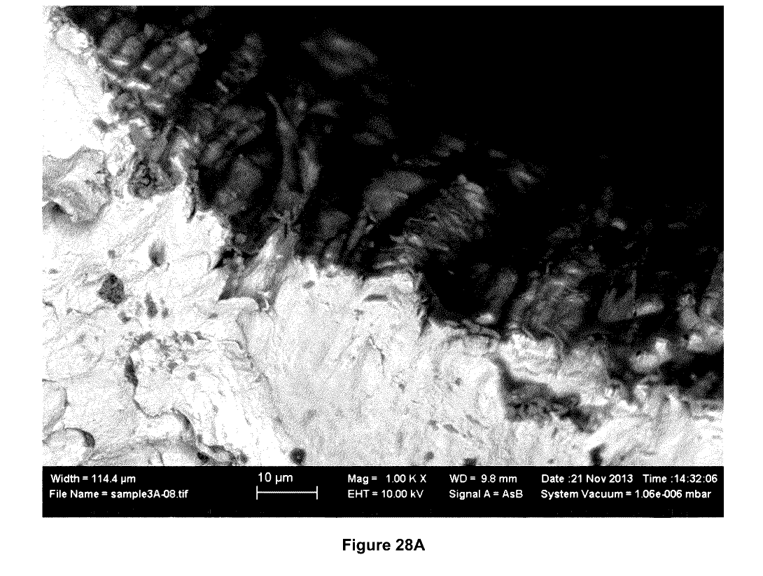

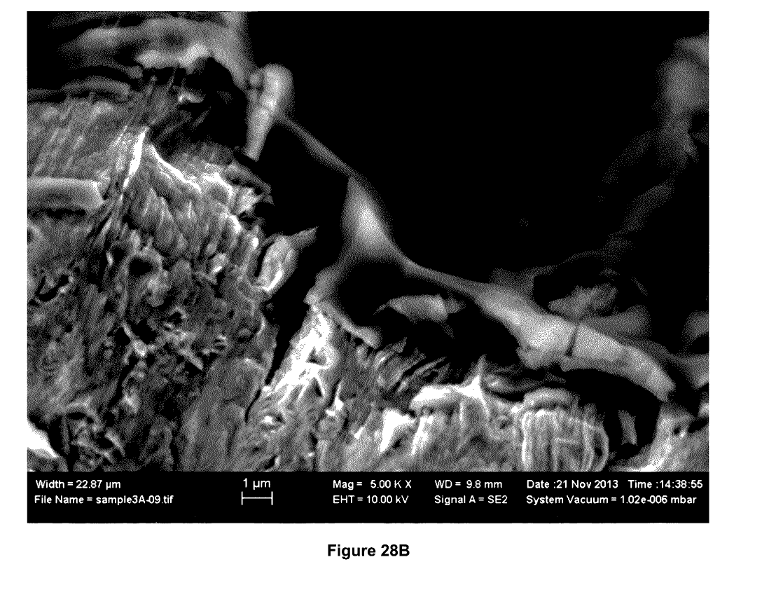

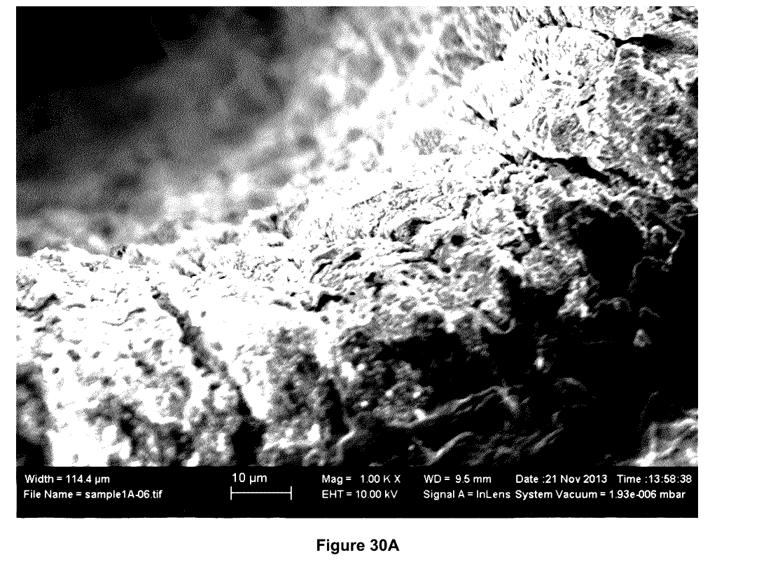

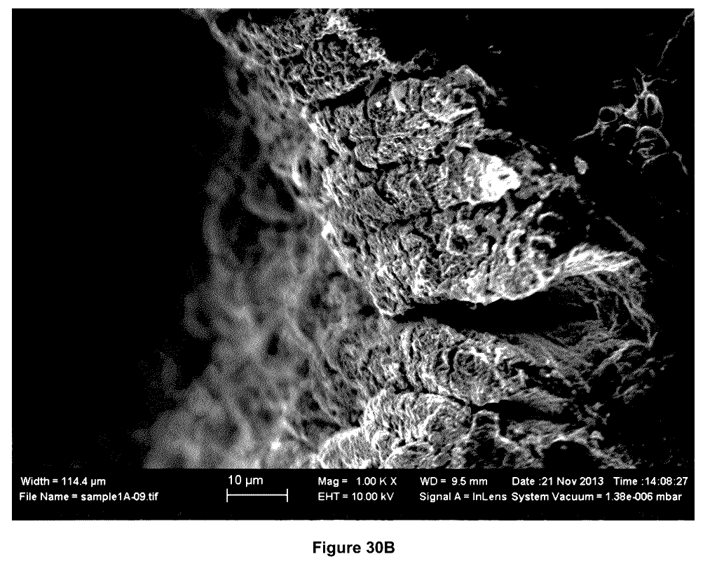

FIGS. 28 a and b show higher magnification images of the untreated PDMS in cross section. These images correlate to the images of FIG. 28. FIGS. 30 a and b show higher magnification images of the PDMS in cross section after treatment. These images correlate to the images of FIG. 30.

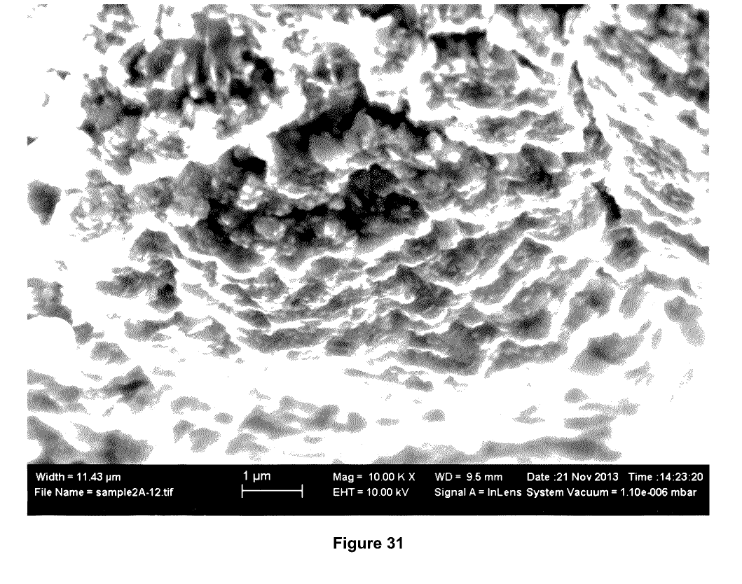

FIG. 31 is a further image showing the particulate structure of the capillary internal coating material after treatment.

Based on the results shown in the figures above it has been found that the modified stationary phase coating does not share the same atomic composition as PDMS. The overall carbon content of the modified stationary phase coating is decreased relative to the starting material. The nature of the bonds silicon and oxygen share with each other are also different than that of PDMS. The internal coating was found to be very uniform consisting of nanoparticles measuring ˜500 nm in diameter.

While not wishing to be bound by theory, preliminary analysis suggests that the treatment process may be producing SiCx and SiOx.

### Example 3

### Capillary Coating Materials

Capillary columns in the treated and untreated form were tested for their ability to serve as an effective trap for GC×GC modulation. Four different commercially available conductive capillary columns have been studied. (Columns were obtained from Restek Corporation, Bellefonte Pa., USA)

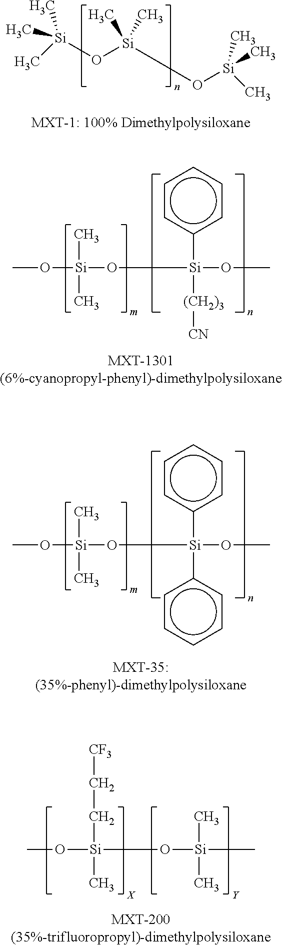

The four capillary columns were prepared in the untreated form and in the treated form, the treated form being treated according to Example 1 above.

Each of the treated and untreated capillary columns were tested as the trap in a 2-dimensional GC analysis of diesel. The following experimental conditions were followed for each analysis:
Sample: Pump Diesel
C:MSDCHEM/1/DATA/Matted2
Primary Column: VF5 ms 27 m×0.25 mm×0.10 μm
Secondary Column: SolGel Wax 0.5 m×0.25 mm×0.25 μm
Restrictor: 0.05 m×0.05 mm transfer line
Inlet:300° C.
Split:300:1
Gas Saver: Yes, 15 ml/min at 5 min
Flow Rate: 2.3 ml/min
Pressure: 20 psi H2 @ 40° C.
FID: 300° C., H2-40 ml/min, Air-400 ml/min, N2-45 ml/min
Oven Program: 40° C., 8° C./min to 240° C., 20° C./min to 260° C., hold 5 min (31 min run time)
Modulation Period: 8 s
Discharge 0.28 mm ID Traps: (7), 50.278 V, 339° C.
Discharge 0.25 mm ID Traps: (3.7), 26.5 V, 339° C.
Full Peltier Cooling: Yes
Method file: DIESEL. M
Flattened traps (treated and untreated)
Best case scenario analysis—diesel at ideal trap loading and desorption temperatures

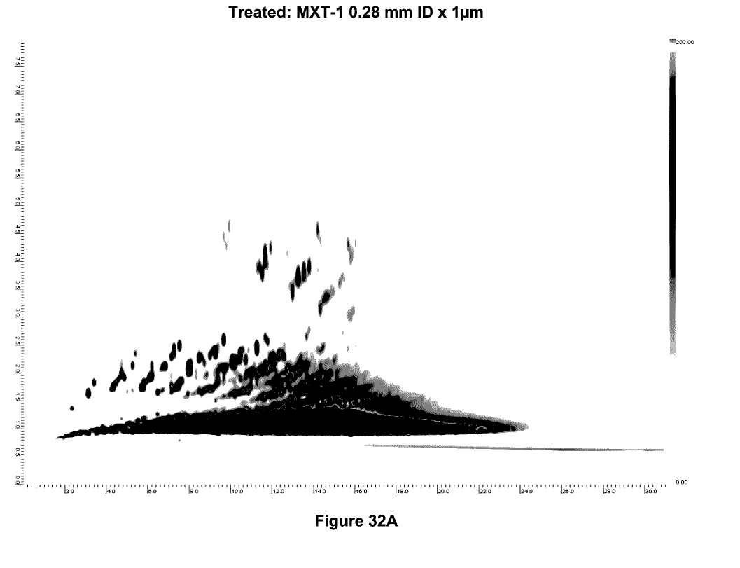

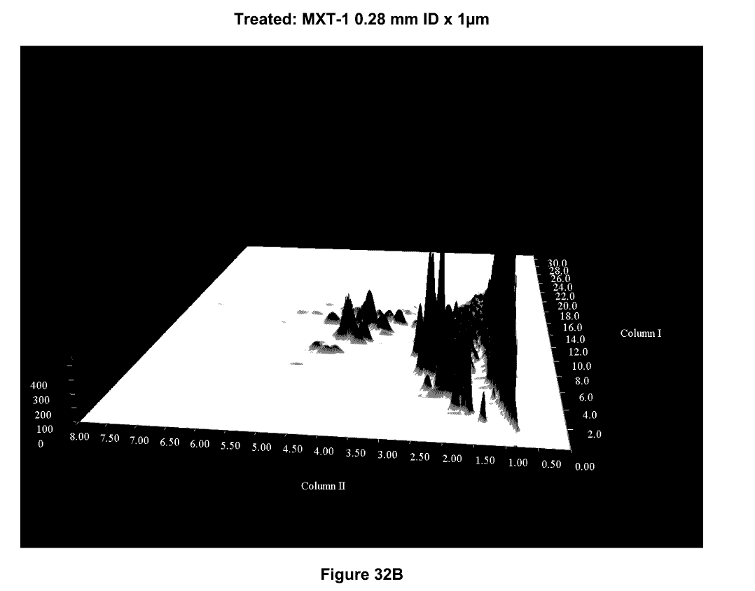

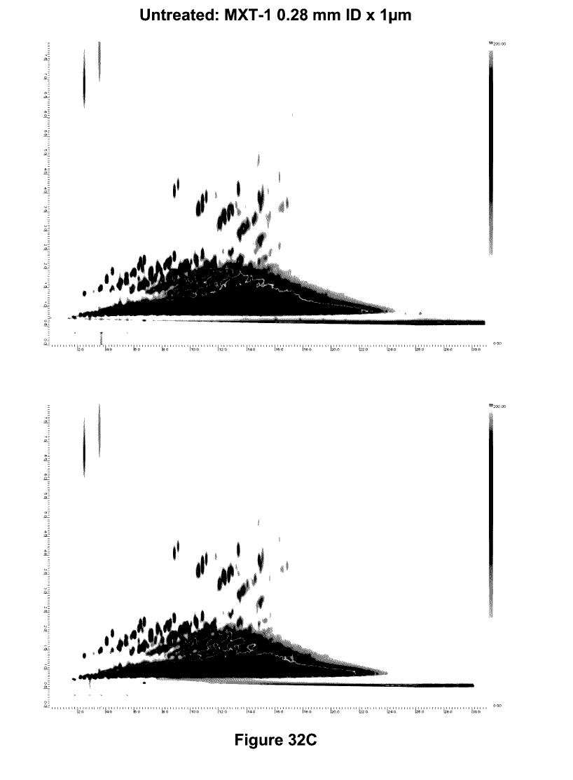

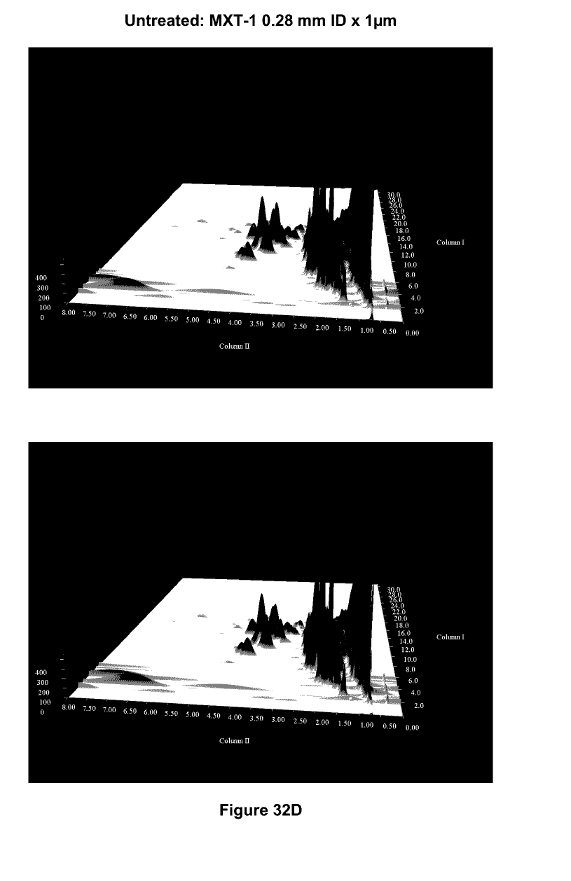

FIGS. 32 a-d show graphs of results from the 2-dimensional GC analysis performed using MXT-1 capillary columns having a diameter of 0.28 mm and a stationary phase film thickness of 1 μm. FIG. 32a is a two dimensional (2D) representation of the results obtained with the treated sample. FIG. 32b is a three dimensional (3D) representation of the same results. FIGS. 32c and 32d are 2D and 3D graphs of the analysis conducted on the untreated column. (The treated column was treated by the method defined in Example 1 above).

From the graphs it can be observed that in the analysis using the untreated column breakthrough of analytes is observed. In addition, bleed is pronounced in analysis using the untreated column. The magnitude of the peaks is found to be similar for the treated and untreated column.

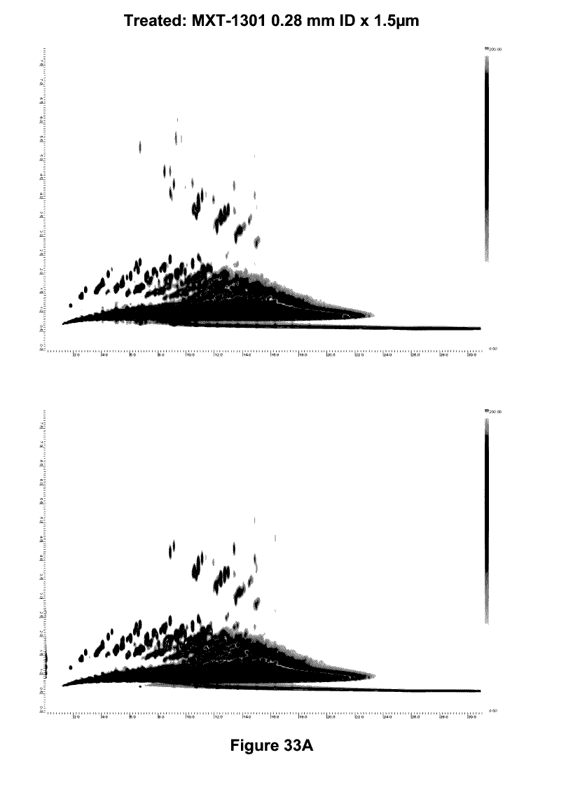

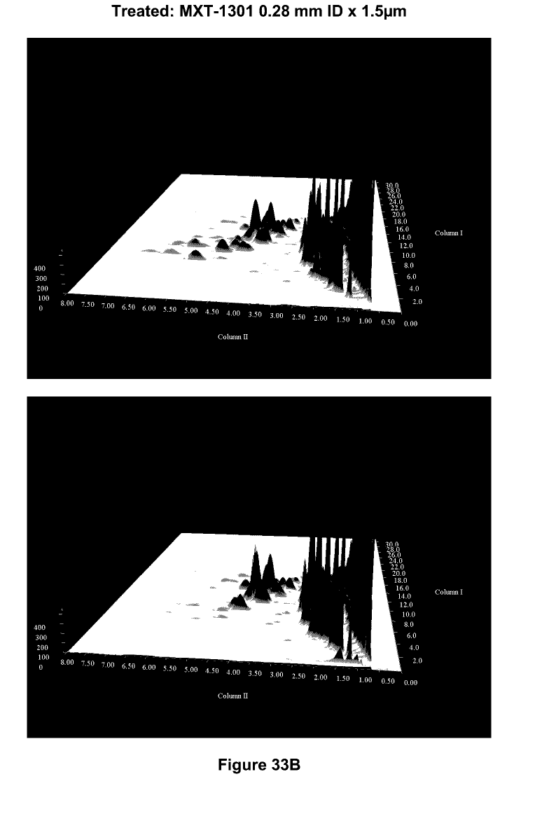

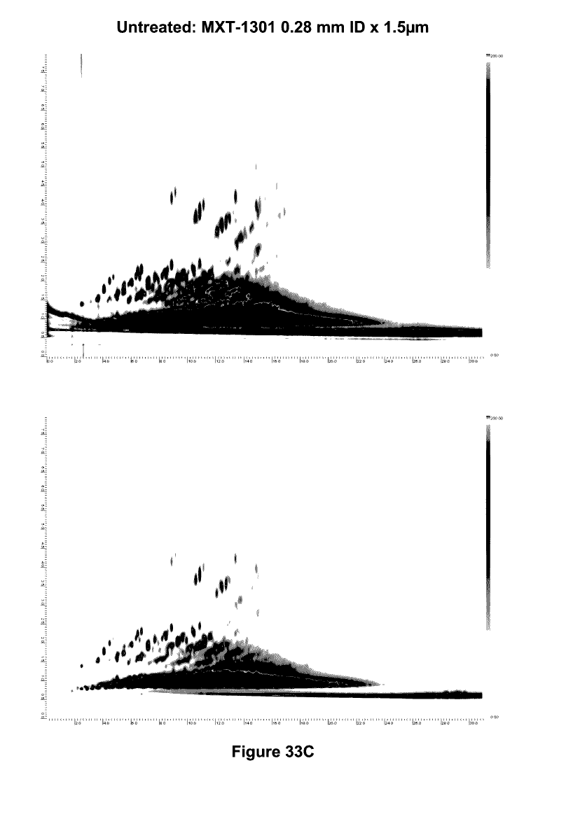

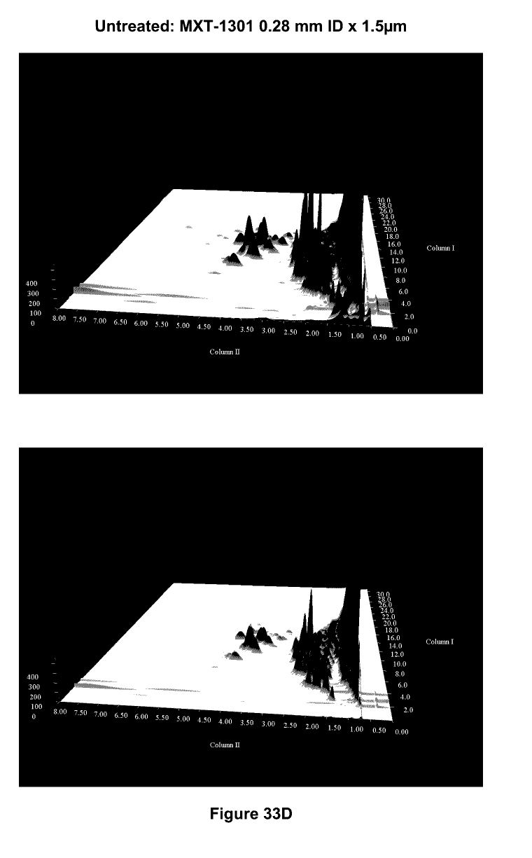

FIGS. 33 a-d show corresponding 2D and 3D graphs of the analysis conducted on MXT-1301 capillary columns having a diameter of 0.28 mm and a stationary phase film thickness of 1.5 μm. In this analysis, the findings were similar to those using MXT-1 columns. The breakthrough and bleed were more pronounced for the untreated column while the magnitude was similar, but in this case appeared to be very slightly less for the column without treatment.

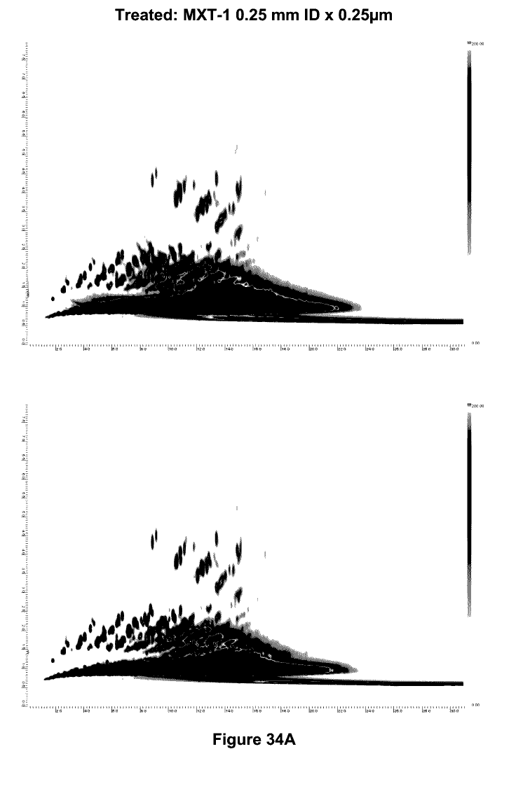

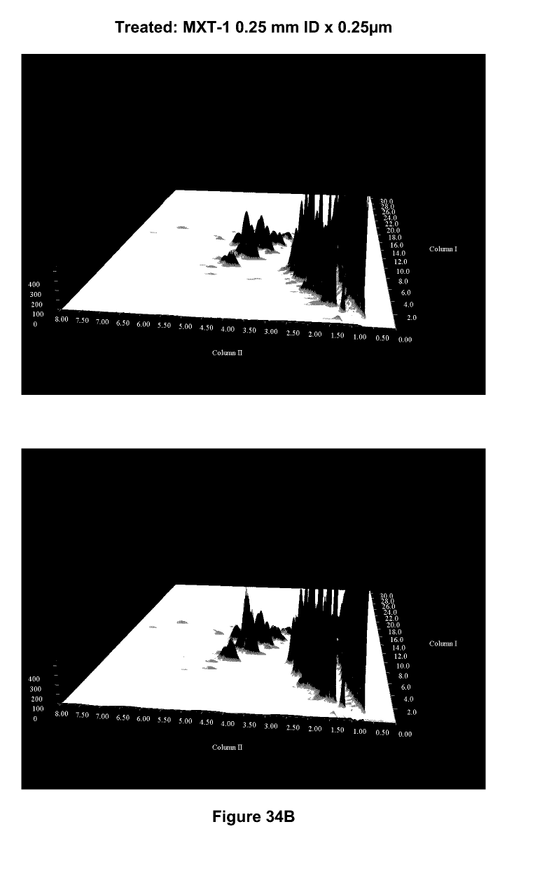

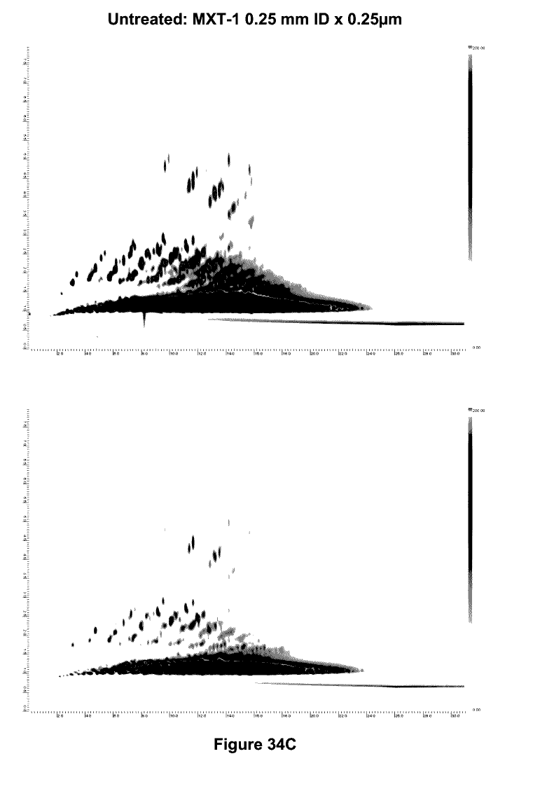

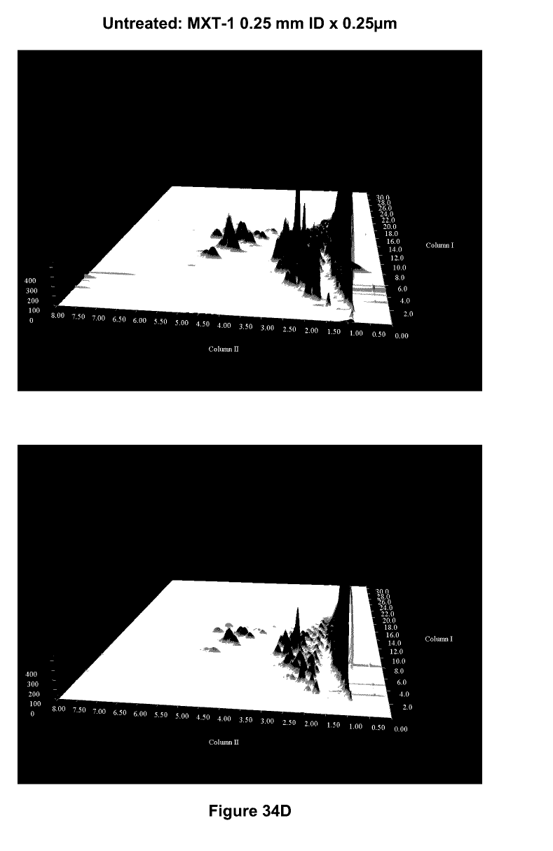

Results for analysis conducted on MXT-1: columns having 0.25 mm and 0.25 μm stationary phase film thickness are shown in FIGS. 34a-d. It was observed that breakthrough was apparent without treatment and bleed was more pronounced. The magnitude of peaks decreased in the case where the column was untreated.

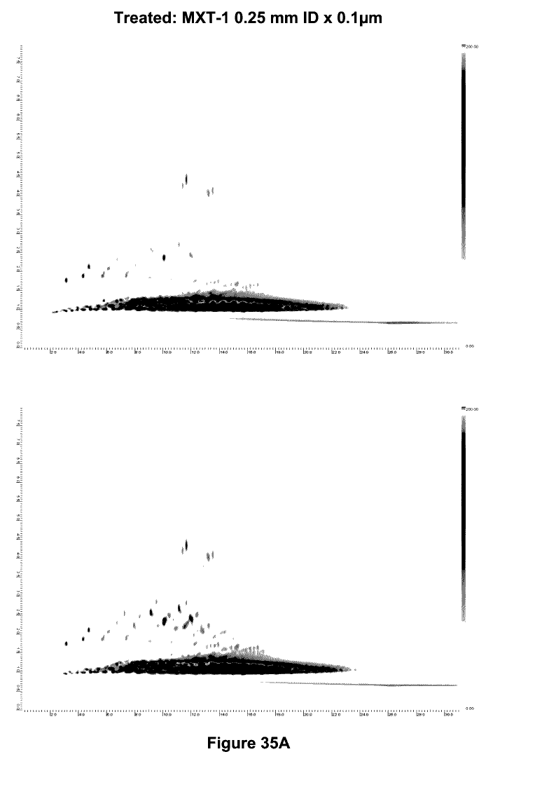

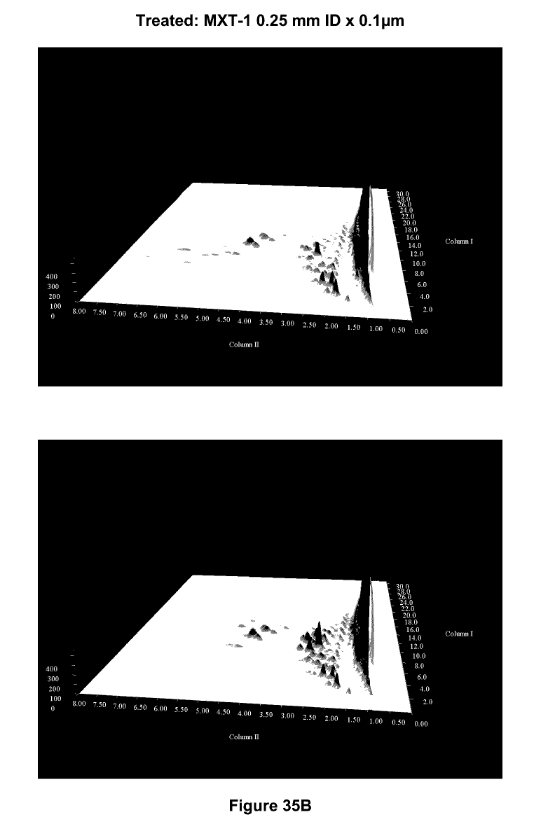

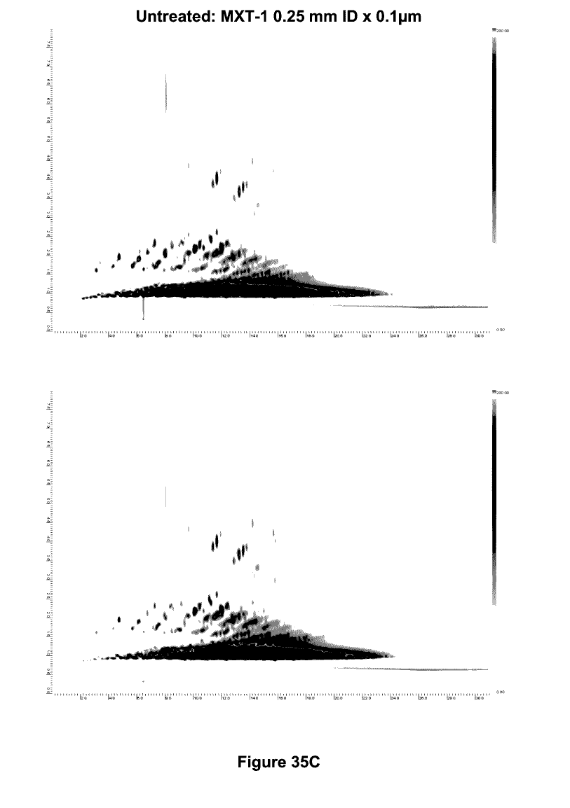

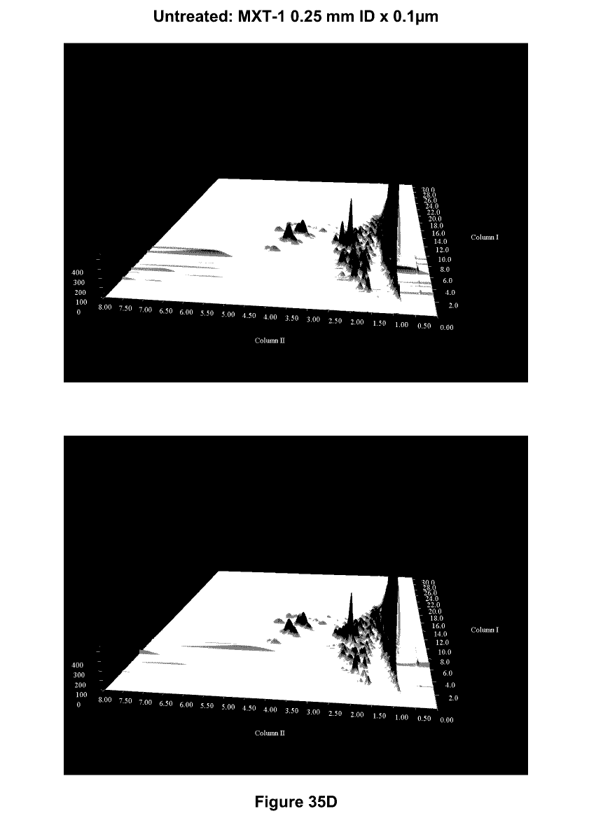

Results for analysis conducted on MXT-1 columns having 0.25 mm and 0.1 μm stationary phase film thickness are shown in FIGS. 35a-d. It was observed that breakthrough was apparent and bleed was more pronounced without treatment. The magnitude of the peaks decreased when the column was treated. While not wishing to be bound by theory, this is believed to be because of the very small thickness of the untreated coating.

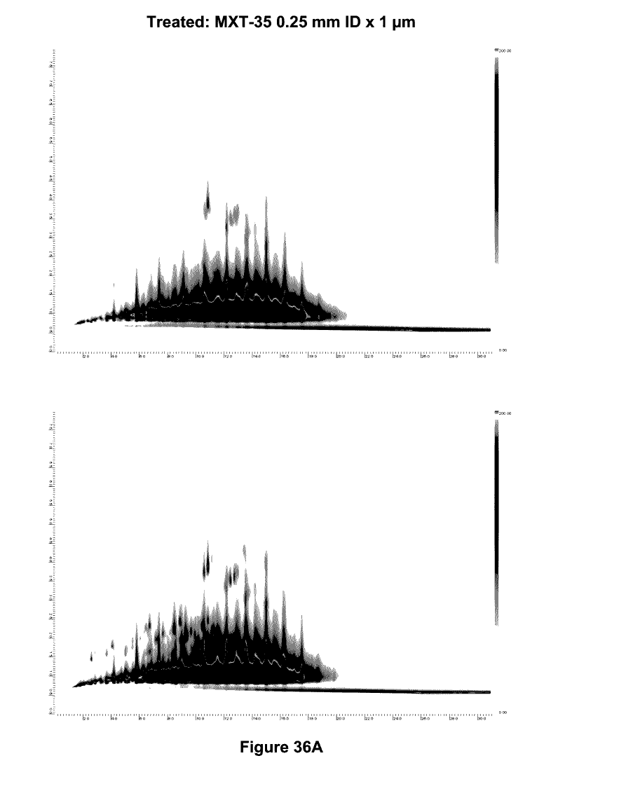

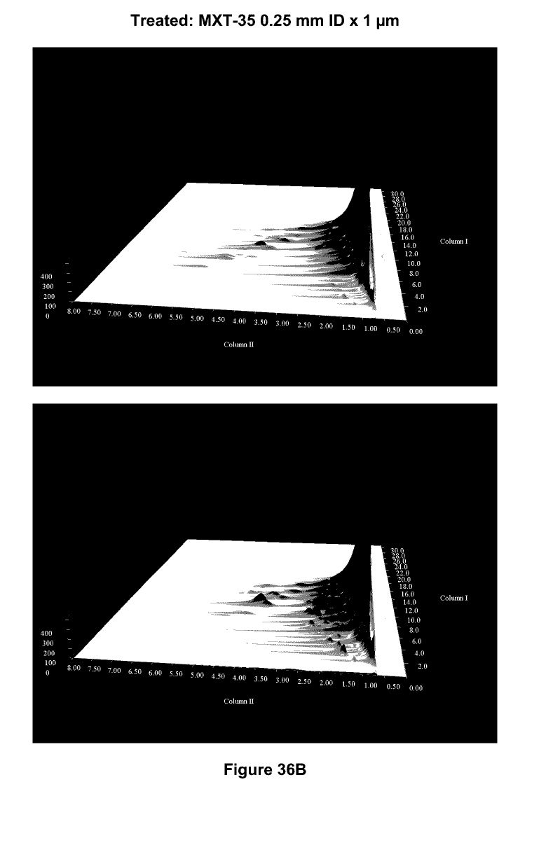

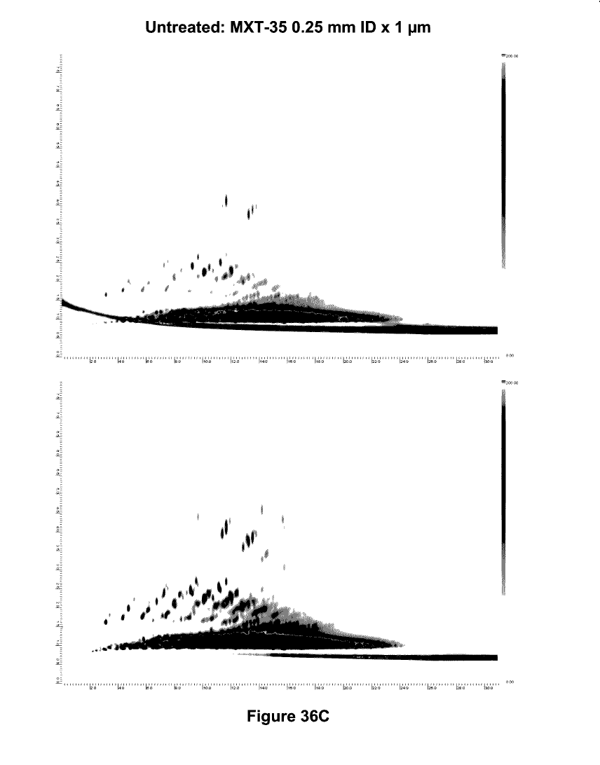

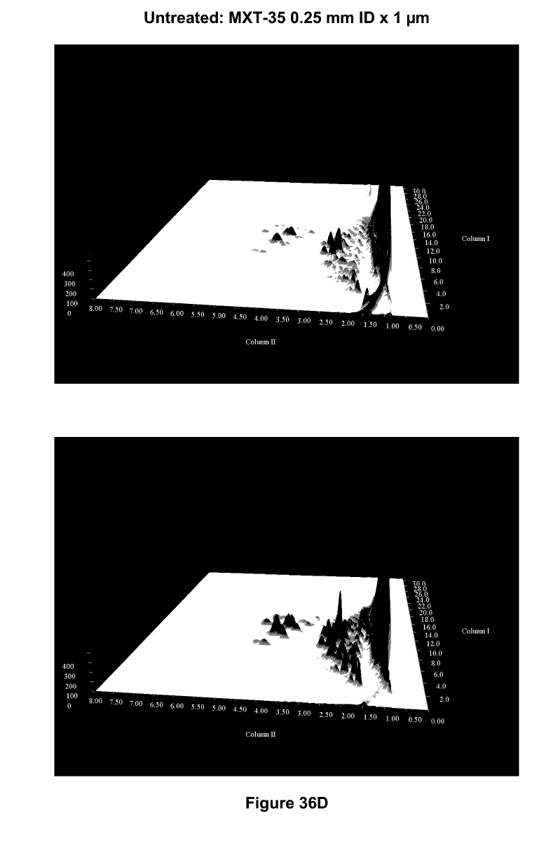

FIGS. 36a-d show the results of analysis on treated and untreated MXT-35 (35%-trifluoropropyl)-dimethylpolysiloxane, 0.25 mm ID×1 μm stationary phase film thickness. From this set of results it was observed that breakthrough was not very apparent in both cases and trap bleed was more pronounced without treatment. It may be concluded that untreated phase, traps and releases much better than treated phase in this case, but performs much worse than the treated PDMS.

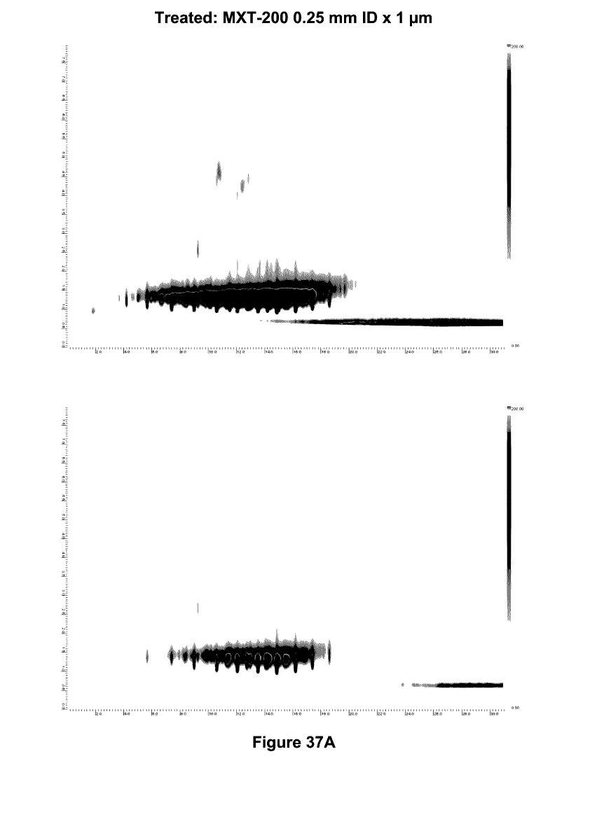

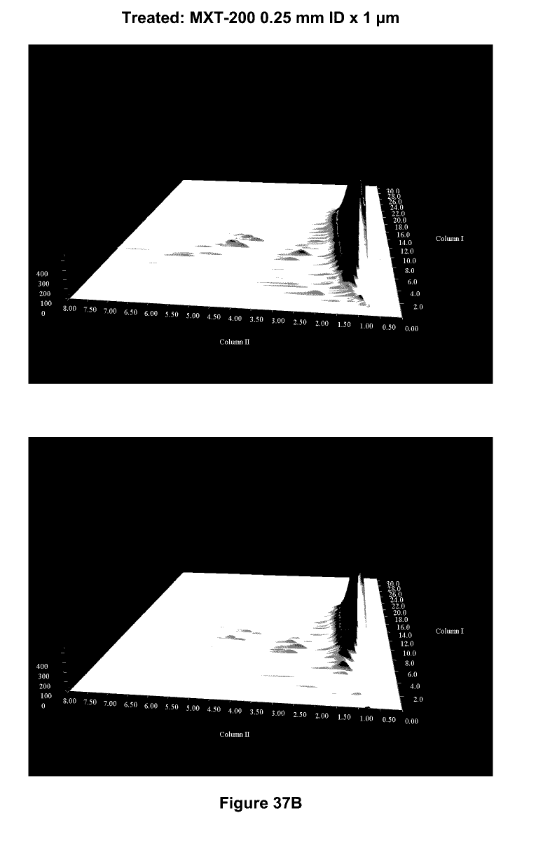

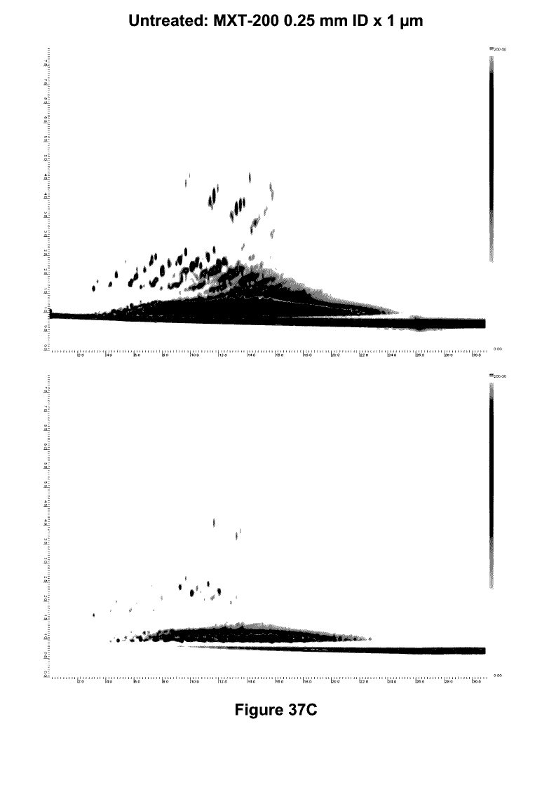

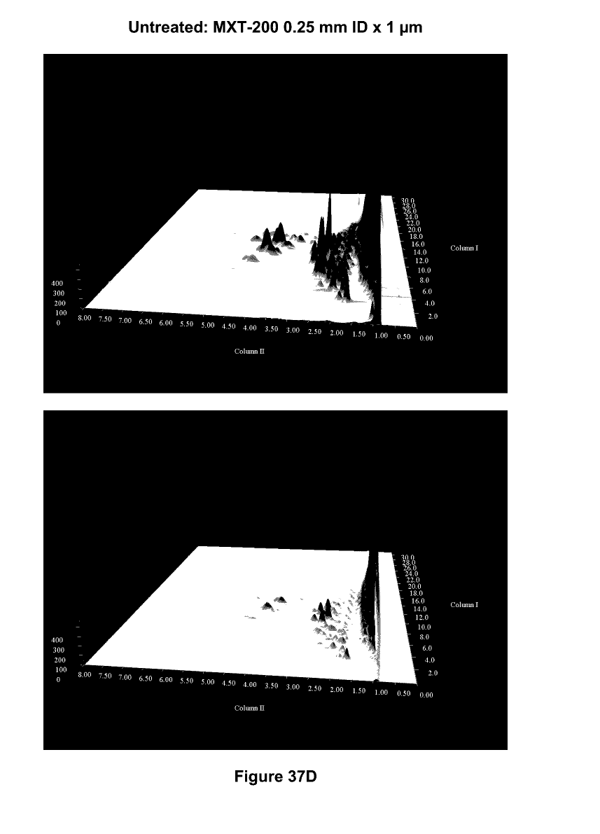

FIGS. 37 a-d show the results of analysis on treated and untreated MXT-200 (35%-trifluoropropyl)-dimethylpolysiloxane 0.25 mm ID×1 μm stationary phase film thickness. It was observed that breakthrough was not very apparent in both cases. Trap bleed was more pronounced without treatment. Untreated phase traps and releases better than treated phase.

### DISCUSSION

The forgoing results indicate that treatment of the capillary columns having 100% PDMS by the method described in example 1 reduces analyte breakthrough. The treatment was also found to increase peak magnitudes in 0.25 μm and 1 μm stationary phase film thickness (df) traps. Treatment was further found to decrease peak magnitudes in 0.1 μm df.

Treatment of the MXT-35 and MXT-200 capillary columns did not provide beneficial effects. These columns did not exhibit an improvement for trapping and release when treated.

### Example 4 Triplicate Alkane Standard Evaluation

The ability of various capillary columns to perform as a trap for GC×GC was evaluated. Four different capillary columns were evaluated: MXT-1 Treated (commercially available capillary column as defined above, treated under the conditions described in Example 1) MXT-1301, MXT-200 and MXT-35 (commercially available capillary columns as described above.)

The columns were tested under the following experimental conditions:
Trap Conditioning Run
Sample: None
C:MSDCHEM/1/DATA/Matted2
Primary Column: VF5 ms 27 m×0.25 mm×0.10 μm
Secondary Column: 0.5 m Rxi-17 Sil ms
Restrictor: 0.05 m×0.05 mm transfer line
Inlet: 300° C.
Split: 100:1
Gas Saver: No
Flow Rate: 1.5 ml/min
Pressure: Various (typically between 14.9 and 15.4 psi)
FID: 300° C., H2-40 ml/min, Air-400 ml/min, N2-45 ml/min
Oven Program: 40° C., 8° C./min to 280° C., hold 20 min
Modulation Period: 4 s
Discharge 0.28 mm ID Traps: (7), 50.278 V, 339° C.
Discharge 0.25 mm ID Traps: (3.7), 26.5 V, 339° C.
Full Peltier Cooling: Yes
Alkane Standard Experimental Conditions
Sample: 1000 ppm C6, C8. C10. C12 in CS2
C:MSDCHEM/1/DATA/Matted2
Primary Column: VF5 ms 27 m×0.25 mm×0.10 μm
Secondary Column: 0.5 m Rxi-17 Sil ms
Restrictor: 0.05 m×0.05 mm transfer line
Inlet: 300° C.
Split: 100:1 (10 ng on column)
Gas Saver: No
Flow Rate: 1.5 ml/min
Pressure: Various (typically between 14.9 and 15.4 psi)
FID: 300° C., H2-40 ml/min, Air-400 ml/min, N2-45 ml/min
Oven Program: 40° C., 8° C./min to 120° C., 20° C./min to 280° C., hold 10 min
Modulation Period: 4 s
Discharge 0.28 mm ID Traps: (7), 50.278 V, 339° C.
Discharge 0.25 mm ID Traps: (3.7), 26.5 V, 339° C.
Full Peltier Cooling: Yes
Method file: ALK11.M
Flattened traps (untreated) with a prior column conditioning run
Best case scenario analysis

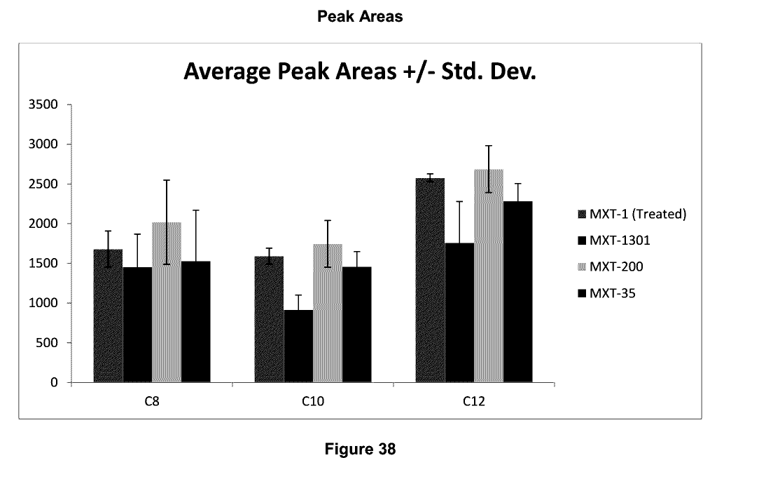

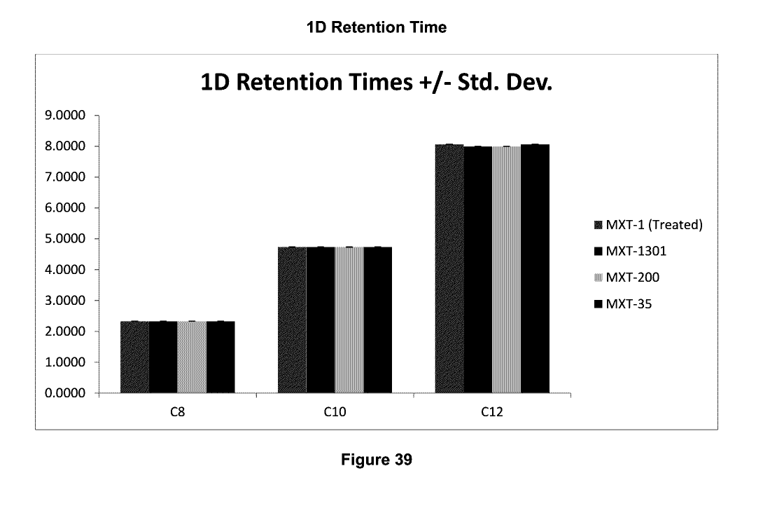

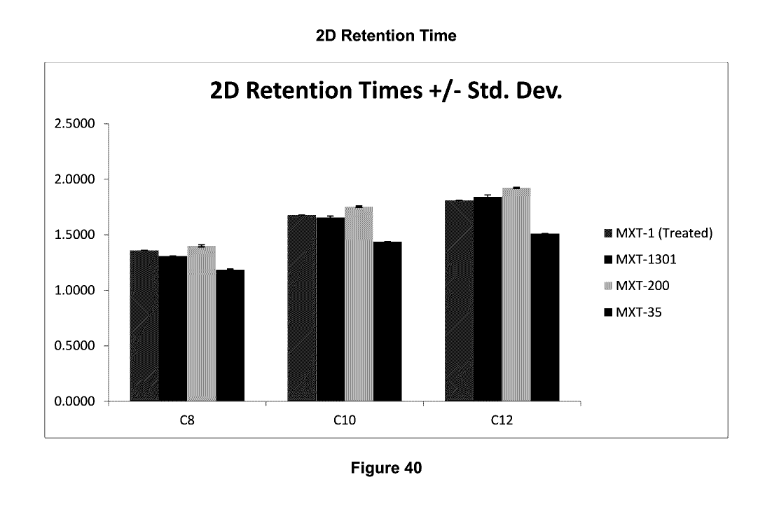

Results of the experiment are shown in FIGS. 38, 39 and 40. FIG. 38 shows the peak area with standard deviation for various chain length alkanes. FIGS. 39 and 40 show the first dimension and the second dimension retention times for C8, C10 and C12 alkanes. The results show that MXT-1 treated and MXT-200 produced the highest overall peak areas of the analytes. MXT-1 treated offers superior reproducibility relative to the other column types tested.

### Example 5

### EDS Study of Capillary Column Material

In this study EDS analysis of the column internal material was done on various treated and untreated capillary columns.

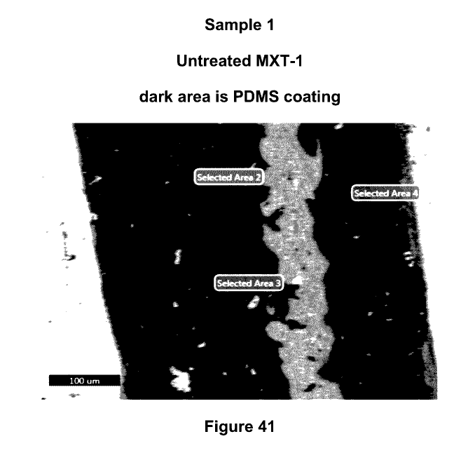

Sample 1 shown in FIG. 41 is untreated MXT-1; in the figure the dark material is the PDMS coating. Sample areas are shown in the figure and the tabular results of the EDS analysis are provided below.

| | |
|---|---|
| | Atomic % from |
| Element | sample |

Area 2

| | |
|---|---|
| Carbon | 54.67 |
| Oxygen | 27.39 |
| Silicon | 31.54 |

Area 3

| | |
|---|---|
| Carbon | 50.38 |
| Oxygen | 28.03 |
| Silicon | 21.59 |

Area 4

| | |
|---|---|
| Carbon | 61.9 |
| Oxygen | 27.24 |
| Silicon | 10.66 |

Average

| | |
|---|---|
| Carbon | 55.65 |
| Oxygen | 27.55333333 |
| Silicon | 21.26333333 |

PDMS

| | |
|---|---|
| Carbon | 50 |
| Oxygen | 25 |
| Silicon | 25 |

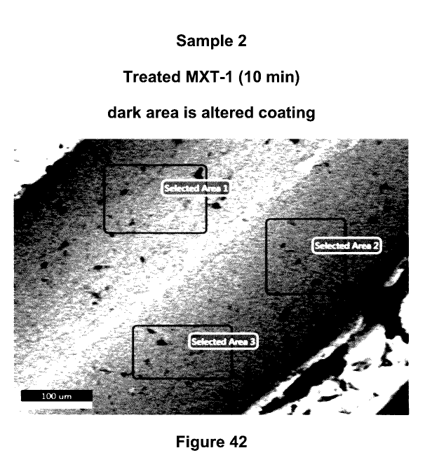

Sample 2, shown in FIG. 42, is MXT-1. The thickness of the coating used in this experiment was 3 μm and the material was treated for 10 min (without further steps of reverse flow and additional discharge). Sample areas are shown in the figure and the tabular results of the EDS analysis are provided below.

| | |
|---|---|
| | Atomic % from |
| Element | sample |

Area 1

| | |
|---|---|
| Carbon | 51.84 |
| Oxygen | 18.75 |
| Silicon | 29.18 |

Area 2

| | |
|---|---|
| Carbon | 26.79 |
| Oxygen | 18.66 |
| Silicon | 54.55 |

Area 3

| | |
|---|---|
| Carbon | 31.31 |
| Oxygen | 18.37 |
| Silicon | 50.33 |

Average Samples 2 and 3

| | |
|---|---|
| Carbon | 29.05 |
| Oxygen | 18.51 |
| Silicon | 52.44 |

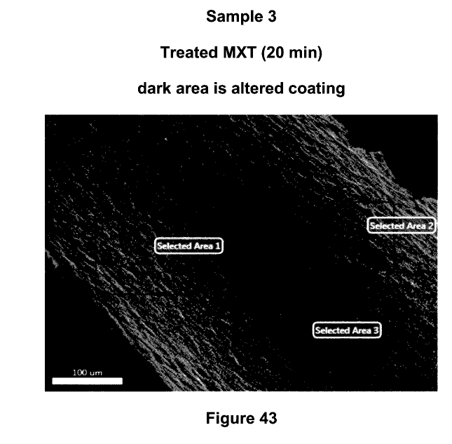

Sample 3, shown in FIG. 43, is MXT-1. The thickness of the coating used in this experiment was 3 μm. The material was treated for 20 minutes total (without further steps of reverse flow and additional discharge). Sample areas are shown in the figure and the tabular results of the EDS analysis are provided below.

| | |
|---|---|
| | Atomic % from |
| Element | sample |

Area 1

| | |
|---|---|
| Carbon | 18.72 |
| Oxygen | 28.39 |
| Silicon | 52.89 |

Area 2

| | |
|---|---|
| Carbon | 37.92 |
| Oxygen | 29.90 |
| Silicon | 32.18 |

Area 3

| | |
|---|---|
| Carbon | 32.02 |
| Oxygen | 27.06 |
| Silicon | 40.92 |

Average Samples 2 and 3

| | |
|---|---|
| Carbon | 34.97 |
| Oxygen | 28.48 |
| Silicon | 36.55 |

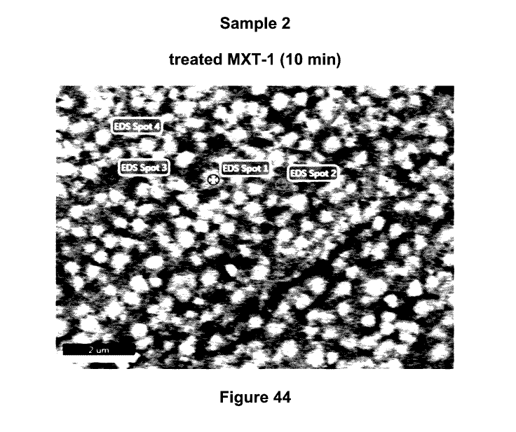

FIG. 44 is a higher magnification image of FIG. 42. FIG. 44 shows the spherical nature of the nanoparticles of sample 2 (described above). The EDS targets specific portions of the sample, for example spots 1 and 4 target the white dots in the image which are the modified PDMS while spots 2 and 3 target the underlying steel.

| | |
|---|---|
| | Atomic % from |
| Element | sample |

Spot 1

| | |
|---|---|
| Carbon | 33.48864298 |
| Oxygen | 14.76412347 |
| Silicon | 51.74723355 |

Spot 2

| | |
|---|---|
| Carbon | 22.35894358 |
| Oxygen | 19.22268908 |
| Silicon | 58.41836735 |

Spot 3

| | |
|---|---|
| Carbon | 24.74531227 |
| Oxygen | 14.49874502 |
| Silicon | 60.75594271 |

Spot 4

| | |
|---|---|
| Carbon | 39.95781226 |
| Oxygen | 16.67922254 |
| Silicon | 43.3629652 |

Average dark spots
(2, 3)

| | |
|---|---|
| Carbon | 23.55212792 |
| Oxygen | 16.86071705 |
| Silicon | 59.58715503 |

Average white spots
(1, 4)

| | |
|---|---|
| Carbon | 36.72322762 |
| Oxygen | 15.72167301 |
| Silicon | 47.55509937 |

PDMS

| | |
|---|---|
| Carbon | 50 |
| Oxygen | 25 |
| Silicon | 25 |

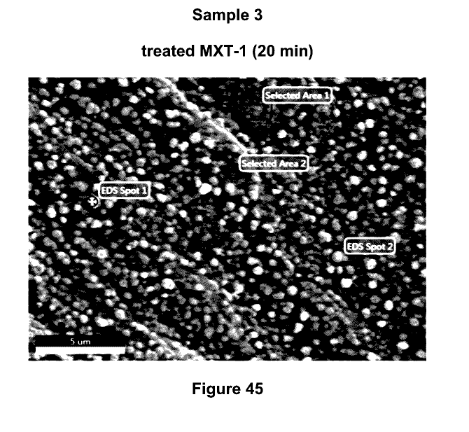

FIG. 45 is a higher magnification image of FIG. 43. FIG. 45 shows the spherical nature of the nanoparticles of sample 3 (described above). The EDS targets specific portions of the sample, for example, area 1 and area 2 are the dark areas which are the underlying steel wall, while spot 1 and spot 2 are targeting the white dots that are modified PDMS.

| | |
|---|---|
| | Atomic % from |
| Element | sample |

Area 1

| | |
|---|---|
| Carbon | 15.35867566 |
| Oxygen | 29.49110975 |
| Silicon | 55.15021459 |

Area 2

| | |
|---|---|
| Carbon | 15.46518792 |
| Oxygen | 18.31484904 |
| Silicon | 66.21996303 |

Spot 1

| | |
|---|---|
| Carbon | 38.61689106 |
| Oxygen | 16.09547124 |
| Silicon | 45.2876377 |

Spot 2

| | |
|---|---|
| Carbon | 23.42113615 |
| Oxygen | 27.11837512 |
| Silicon | 49.46048873 |

Average dark
areas (1, 2)

| | |
|---|---|
| Carbon | 15.41193179 |
| Oxygen | 23.9029794 |
| Silicon | 60.68508881 |

Average white spots
(1, 2)

| | |
|---|---|
| Carbon | 23.42113615 |
| Oxygen | 27.11837512 |
| Silicon | 49.46048873 |

In summary, similar to the preliminary XPS data, the preliminary EDS data suggests that the previously described thermal treatment process modifies PDMS stationary phase coating into a carbon doped, highly oxidised silica material.

While the present invention has been described with reference to particular examples it is to be understood that the invention is not limited to the disclosed examples. To the contrary, the invention is intended to cover various modifications and equivalent arrangements as would be known to a person of skill in the art in view of the description. The scope of the claims should not be limited by the embodiments as set forth in the examples but should be given the broadest interpretation consistent with the description as a whole.

All publications, patents and patent applications referred to in the specification are herein incorporated by reference as if each individual publication, patent or patent application was specifically and individually indicated to be incorporated by reference in its entirety.

1. A material that is a modified PDMS or derivative of PDMS prepared by thermal treatment of a column containing PDMS or a derivative of PDMS at a temperature in the range of about 400° C. to about 1000° C.

2. The material according to claim 1 wherein the column is a capillary column.

3. The material according to claim 2 wherein the capillary column has an outer tube comprising metal or fused silica, and an inner coating of PDMS or a derivative of PDMS.

4. The material according to claim 1 wherein the thermal treatment takes place in the presence of oxygen.

5. The material according to claim 4 wherein a flow of an oxygen containing gas is passed through the column during the thermal treatment.

6. The material according to claim 1 wherein the modified PDMS or derivative of PDMS is in the form of nanoparticles.

7. The material according to claim 1 wherein the thermal treatment comprises heating the column to a temperature in the range of 400° C. to 1000° C. for 1 to 5 heating cycles of 2-15 minutes per cycle.

8. The material according to claim 7 wherein the thermal treatment comprises heating the column to a temperature in the range of 750° C. to 850° C. for 1 cycle of 10 minutes followed by 2 cycles of 5 minutes.

9. A column containing a modified PDMS material or a modified PDMS derivative material prepared by thermal treatment of a column containing PDMS or a derivative of PDMS at a temperature in the range of about 400° C. to about 1000° C.

10. The column according to claim 9 wherein the column is a capillary column having an outer tube comprising metal or fused silica and an inner coating of PDMS or a derivative of PDMS.

11. The column according to claim 9 wherein the thermal treatment process takes place in the presence of oxygen.

12. The column according to claim 11 wherein a flow of an oxygen containing gas is passed through the column during thermal treatment.

13. The column according to claim 9 wherein the modified PDMS or derivative of PDMS is in the form of nanoparticles.

14. The column according to claim 9 wherein the thermal treatment comprises heating the column to a temperature in the range of 400° C. to 1000° C. for 1-5 heating cycles of 2-15 minutes per cycle.

15. The column according to claim 9 wherein the thermal treatment comprises heating the column to a temperature in the range of 750° C. to 850° C. for 1 cycle of 10 minutes followed by 2 cycles of 5 minutes.

16. The use of a column according to claim 9 for chromatography.

17. The use of a column according to claim 9 for liquid chromatography (LC) high performance liquid chromatography (HPLC), gas chromatography (GC), solid phase extraction (SPE) or solid phase microextraction (SPME).

18. The use of a column according to claim 17 wherein the column is used as a modulator between columns for 2-dimensional GC.

19. The column according to claim 9 wherein the column contains a modified PDMS material prepared by thermal treatment of a column containing PDMS.

20. A method of preparing a modified PDMS or PDMS derivative comprising thermal treatment of a column containing PDMS or a derivative of PDMS at a temperature in the range of 400° C. to about 1000° C.
